(19) United States
(12) Patent Application Publication
(10) Pub. No.: US 2026/0189941 A1
(43) Pub. Date: Jul. 2, 2026

(54) MANAGEMENT OF SIMULATED USER EQUIPMENT (UE) FOR DISTRIBUTED UNIT (DU) CAPACITY EVALUATION

(71) Applicant: Rakuten Symphony, Inc., Tokyo (JP)

(72) Inventors: Argha MUKHERJEE, Karnataka (IN); Amiya Gangopadhyay, Karnataka (IN)

(73) Assignee: Rakuten Symphony, Inc., Tokyo (JP)

(21) Appl. No.: 19/001,941

(22) Filed: Dec. 26, 2024

(51) Int. Cl. H04W 24/06; H04W 8/18; H04W 74/0833

(52) U.S. Cl. CPC H04W 24/06; H04W 8/183; H04W 74/0833

(57) ABSTRACT

Example embodiments of the present disclosure relate to the management of simulated user equipment (UE) for distributed unit (DU) capacity evaluation. According to example embodiments, a UE simulator may be implemented. The UE simulator may include a Layer 2 (L2)-simulator and a Multi-UE Cell Emulator (MUCE). The L2-simulator may be configured to receive data from a Layer 1 (L1)-forwarder of a DU and the MUCE. Further, the L2-simulator may be configured to forward data to the MUCE and the L1-forwarder of the DU. Furthermore, the L2-simulator may be configured to simulate L2 functionalities of a UE. The MUCE may be configured to simulate Layer 3 (L3 ) functionalities of the UE.

### TECHNICALFIELD

The present disclosure relates to the management of simulated user equipment (UE) for distribute unit (DU) capacity evaluation.

### BACKGROUND

The information disclosed in this background section is only for the enhancement of understanding of the general background of the disclosure and should not be taken as an acknowledgement or any form of suggestion that this information forms the prior art already known to a person skilled in the art.

In a telecommunications network, a Radio Access Network (RAN) in a base station (e.g., 5G gNodeB, LTEeNodeB, etc.) may be disaggregated into separate units such as: a centralized unit/central unit (CU) that manages non-real-time operations and higher-layer protocols (primarily Layer 3 and above) such as control-plane functions and interactions with a core network, a distributed unit (DU) that manages real-time (or near-real-time) operations and lower-layer protocols (primarily Layer 1 to Layer 2) such as radio resource scheduling and handover controls between a user equipment (UE) and the network, and a radio unit (RU) that contains radio frequency (RF) components (e.g., antennas, etc.) for receiving signals from the UE and transmit the signals to the DU.

Since the DU is a critical component in processing and managing large amounts of signaling and user data, it is important to evaluate the DU capacity which affects the DU capabilities in handling loads. In this regard, the DU capacity may be tested and evaluated with simulated UEs.

### SUMMARY

Example embodiments of the present disclosure provide a system, a device, a method, and the like, that leverages various novel mechanisms associated with the management of simulated UE for DU capacity evaluation.

According to example embodiments, a UE simulator may be implemented. The UE simulator may include a Layer 2 (L2)-simulator and a Multi-UE Cell Emulator (MUCE). The L2-simulator may be communicatively coupled to the MUCE and a Layer 1 (L1)-forwarder of a distributed unit (DU) of a telecommunication network. The MUCE may be communicatively coupled to the L2-simulator and a test automation controller (TAC) configured to receive a simulation requirement from a user. The L2-simulator may be configured to receive a first data from the L1-forwarder of the DU and receive a second data from the MUCE. Further, the L2-simulator may be configured to forward the first data to the MUCE and forward the second data to the L1-forwarder of the DU. Furthermore, the L2-simulator may be configured to simulate, based on at least one of the first data and the second data, L2 functionalities of a UE. The MUCE may be configured to simulate, based on at least one of the first data and the simulation requirement, Layer 3 (L3) functionalities of the UE.

According to example embodiments, a method may include: receiving, by an L2-simulator of a UE simulator, a first data from an L1-forwarder a DU of a telecommunication network; forwarding, by the L2-simulator, the first data to a MUCE of the UE simulator; receiving, by the L2-simulator, a second data from the MUCE; forwarding, by the L2-simulator, the second data to the L1-forwarder of the DU; simulating, by the L2-simulator and based on at least one of the first data and the second data, L2 functionalities of a UE; and simulating, by the MUCE and based on at least one of the first data and a simulation requirement received by the MUCE from a TAC, L3 functionalities of the UE.

According to example embodiments, a non-transitory computer-readable recording medium may have recorded thereon instructions executable by a UE simulator to cause the UE simulator to perform a method. The method may include: receiving, by an L2-simulator of a UE simulator, a first data from an L1-forwarder a DU of a telecommunication network; forwarding, by the L2-simulator, the first data to a MUCE of the UE simulator; receiving, by the L2-simulator, a second data from the MUCE; forwarding, by the L2-simulator, the second data to the L1-forwarder of the DU; simulating, by the L2-simulator and based on at least one of the first data and the second data, L2 functionalities of a UE; and simulating, by the MUCE and based on at least one of the first data and a simulation requirement received by the MUCE from a TAC, L3 functionalities of the UE.

Additional aspects will be set forth in part in the description that follows and, in part, will be apparent from the description, or may be realized by practice of the presented embodiments of the disclosure.

### BRIEFDESCRIPTION OFTHEDRAWINGS

Features, aspects, and advantages of embodiments of the disclosure will be described below with reference to the accompanying drawings, in which like reference numerals denote like elements, and wherein:

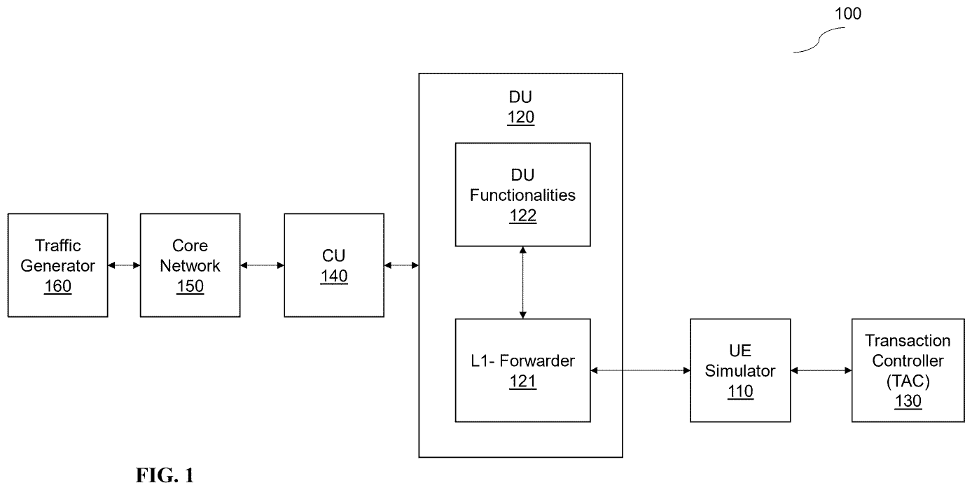

FIG. 1 illustrates a block diagram of an example system architecture, according to one or more example embodiments;

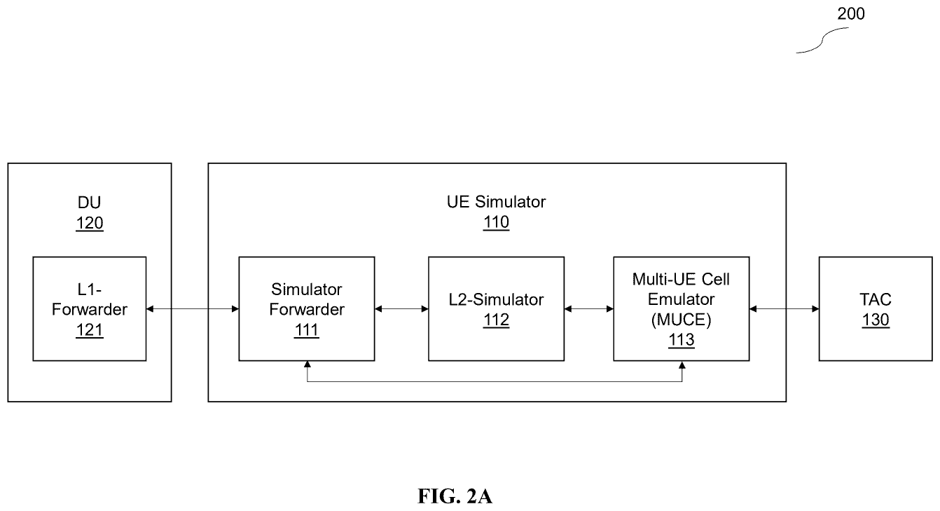

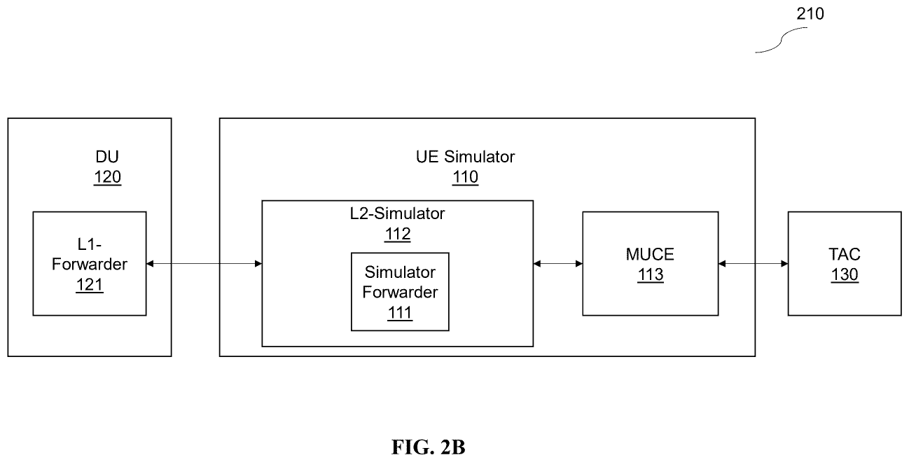

FIGS. 2A-2B each illustrates a block diagram of an example configuration between the components of a UE simulator, a DU, and a Test Automation Controller (TAC), according to one or more example embodiments;

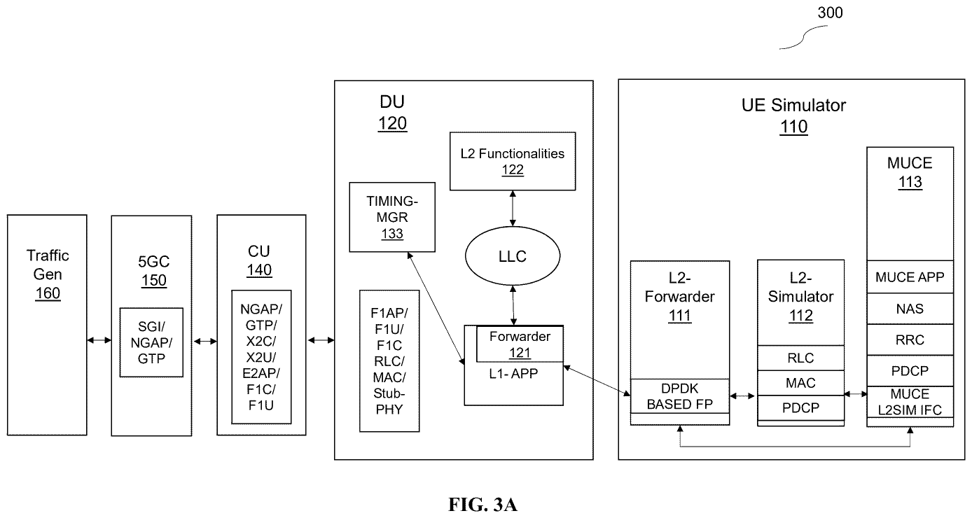

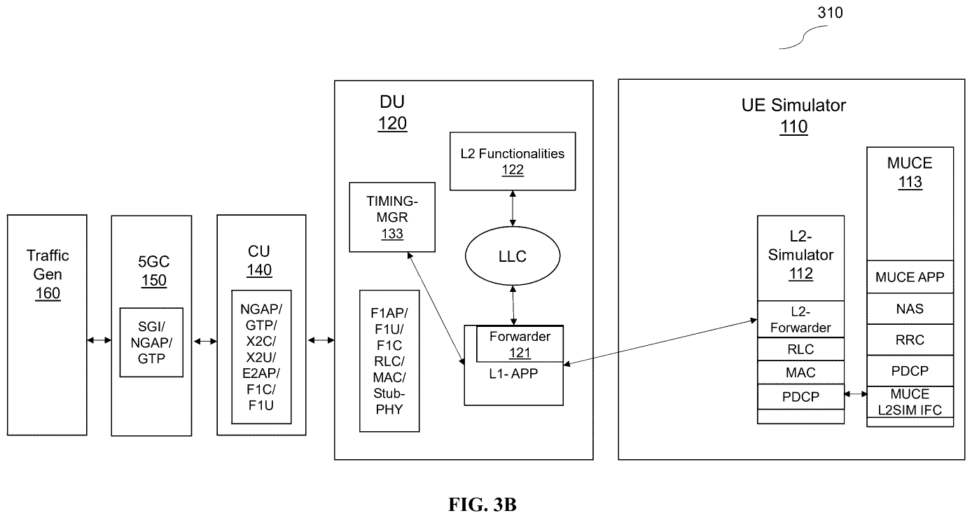

FIGS. 3A-3B each illustrates a block diagram of an example system configuration for evaluating Layer 2 (L2) capacity of the DU, according to one or more example embodiments;

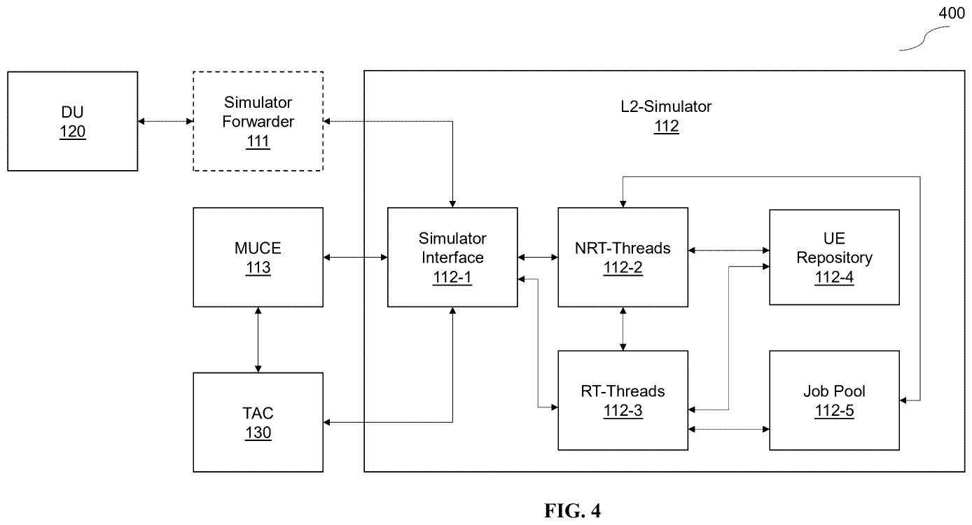

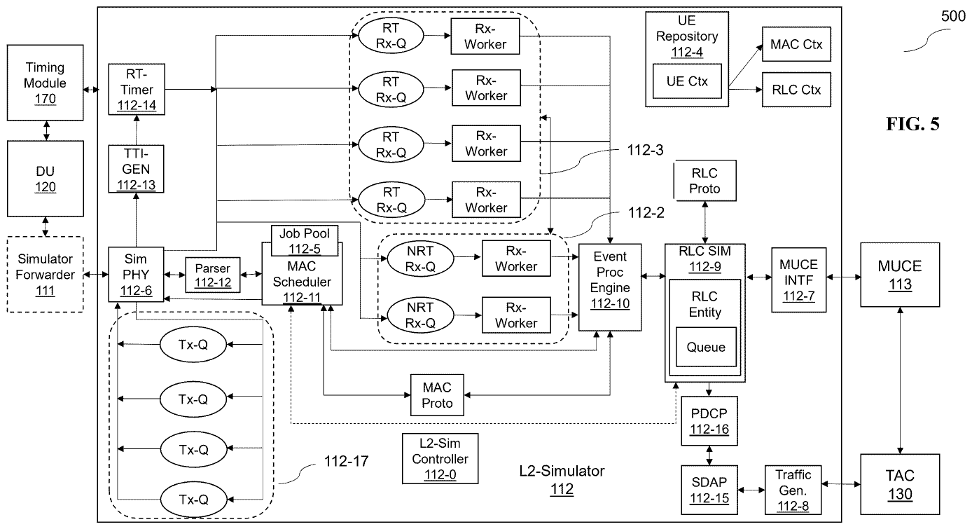

FIG. 4 illustrates a block diagram of an example configuration between components of an L2-simulator and other components, according to one or more example embodiments;

FIG. 5 illustrates a block diagram of an example configuration, in which the L2-simulator includes additional components, according to one or more example embodiments;

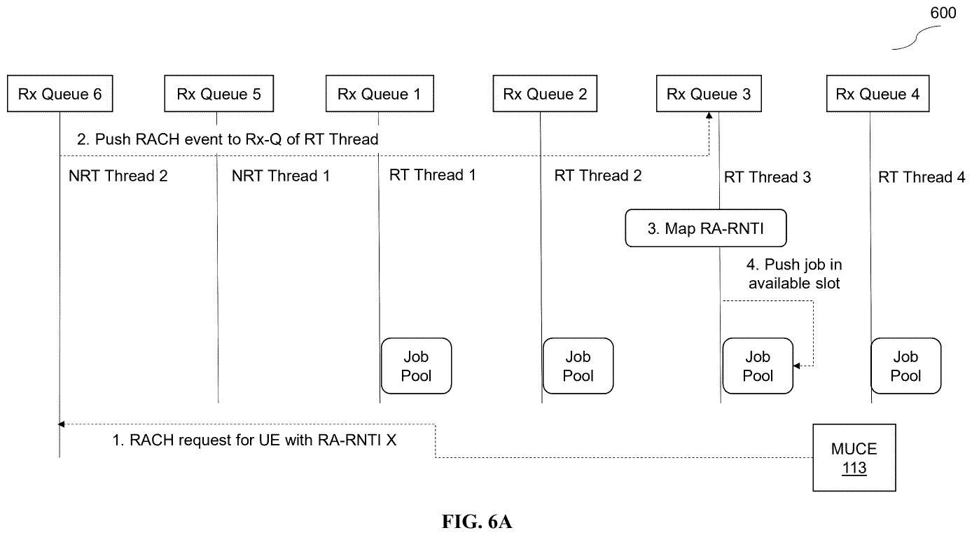

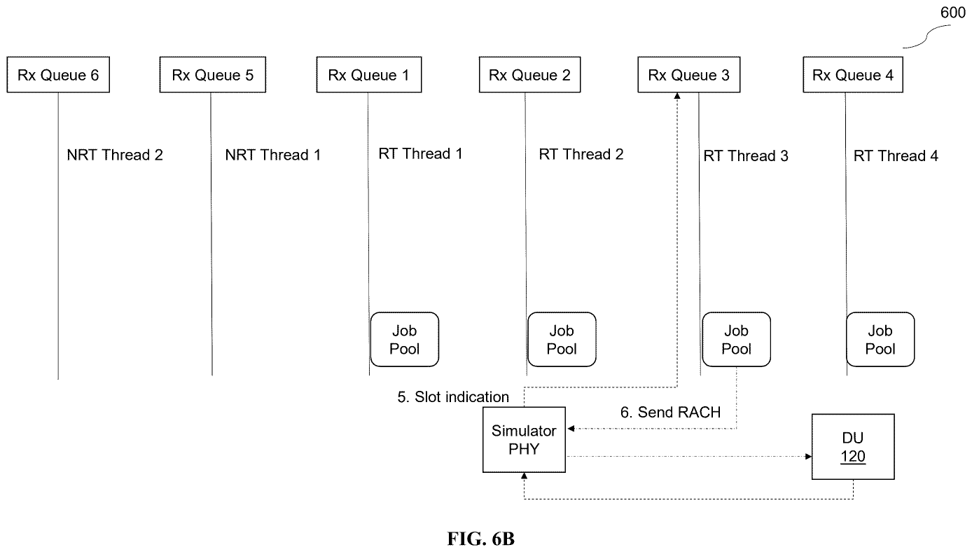

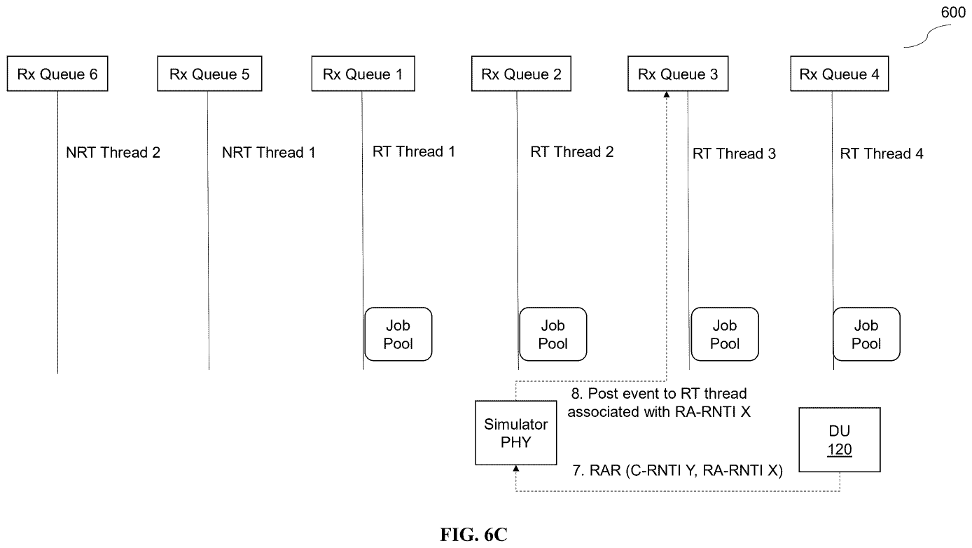

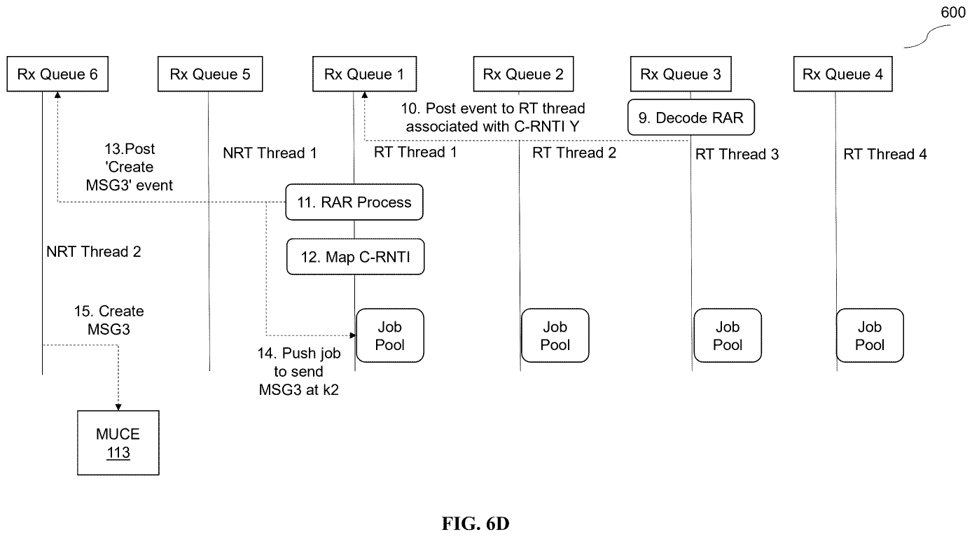

FIGS. 6A-6D illustrate flow diagrams of an example use case, according to one or more example embodiments;

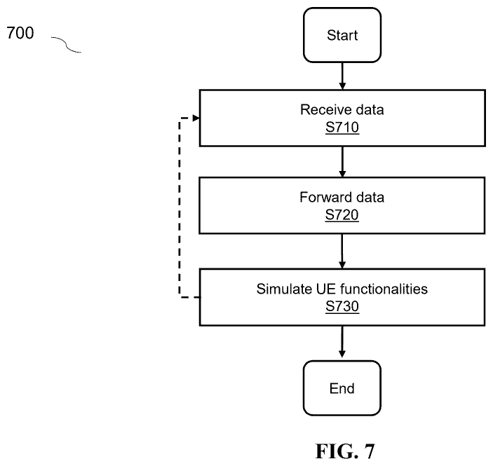

FIG. 7 illustrates a flow diagram of an example method, according to one or more example embodiments.

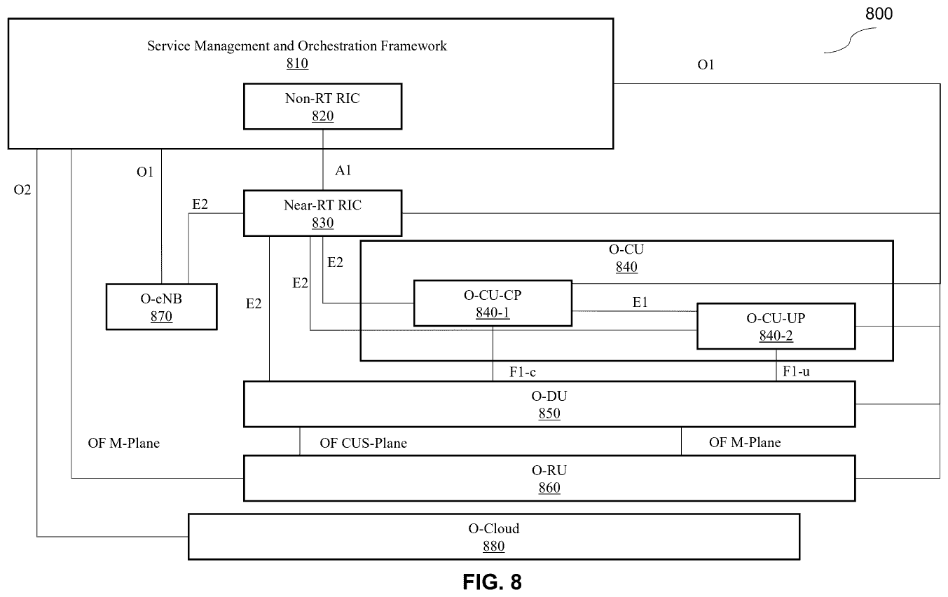

FIG. 8 illustrates a block diagram of an O-RAN architecture, according to one or more example embodiments; and

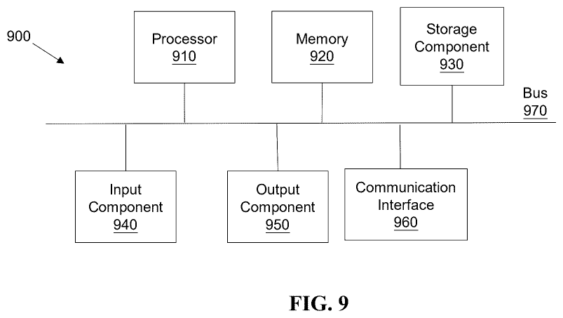

FIG. 9 illustrates an embodiment of a device in which one or more example embodiments may be implemented.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

It shall be noted that, descriptions of example embodiments of the present disclosure may include terms and names defined in one or more standard organizations, such as the Open Radio Access Network (O-RAN) Alliance, the 3rd Generation Partnership Project (3GPP) standard organization, the European Telecommunications Standards Institute (ETSI) standard organization, and the like. For instance, the terms “CU”, “DU”, “RU”, “L1”, “L2”, “L3”, “MAC”, “RLC”, “RRC”, and the like, as well as the associated features and operations, are to be interpreted as consistent with those specified in one or more technical specifications, unless being described otherwise.

As described above, a distributed unit (DU) in a radio access network (RAN) is a key component that manages the lower layers of the radio protocol stack, thereby providing essential functionalities that communicatively couple a user equipment (UE) and a centralized unit (CU) in the RAN. The DU is typically located closer to the end-users (and thus closer to the UEs) to minimize latency and optimize efficiency in handling real-time (or near-real-time) operations, and is primarily responsible for real-time (or near-real-time) operations (e.g., scheduling, etc.) associated with Layer 1 (L1) Physical Layer and Layer 2 (L2) Data Link Layer. In addition, the DU also plays an important role in handling data packets or messages associated with Layer 3 (L3) Network Layer, such as processing, receiving, and forwarding of L3 data packets/messages between the UE and the CU.

Evaluating the capacities of a DU, such as the maximum L1/L2/L3 capacities of the DU, is important to determine the maximum load handling capabilities of the DU. In this regard, evaluating the DU with a UE simulated by a UE simulator (may be referred to as a “simulated UE” herein) may be more efficient and flexible than evaluating the DU with a real UE, since the simulations allow for customizing and testing a wide range of scenarios (e.g., simulating large number of UEs to incur extreme loads to evaluate the limitations of the DU, simulating rare use cases that are difficult/costly to implement with the real UE, etc.) which are either impractical or too costly to recreate with real UE. Furthermore, the UE simulator also provides a controlled environment that ensures consistency in the evaluation results, while maintaining a safe and efficient testing process (e.g., without requiring the user to visit the site in which the DU is implemented, etc.).

Although the concept of utilizing the UE simulator in evaluating DU capacity is introduced in the related art, the UE simulators in the related art are for performing end-to-end testing which mainly evaluates the L1 capacities of the DU and may require the implementation of a radio unit (RU) to communicatively couple the DU and the UE simulator. The related art UE simulators, however, are not suitable or optimized for evaluating the maximum load-handling capabilities of L2 and L3 in the DU, due to the limitations of the RU (e.g., limitation in supported capacity, speed, etc.).

In addition to the limitations due to the RU, the related art UE simulators themselves may face complexity and difficulty in managing the simulated UEs, particularly when the number of simulated UEs is large. Specifically, since one UE simulator itself may act as one UE and has a single Media Access Control (MAC) layer (i.e., a sublayer of L2 in the UE), all simulated UEs may share the same MAC layer. In this regard, although one of the objectives in the UE-simulator is to simulate multiple UEs (with a single MAC layer), how to effectively and efficiently manage the simulated UEs (e.g., schedule and distribute the simulated UEs amongst the resources (e.g., computing cores, etc.) of the UE simulator) are challenging and complex, which may in turn result in the restriction of the number of UEsthat can be simulated (e.g., some UE simulators may limit the maximum number of UEs that can be simulated, in order to avoid over-complexity of the management of the simulated UEs, etc.).

Example embodiments of the present disclosure, as described in the following, provide devices, systems, methods, and the like, that effectively and efficiently manage the simulated UE for DU capacity evaluation (particularly, L2 and L3 capacities of the DU), and ultimately address the shortcomings of the related art systems and methods.

Specifically, example embodiments may implement a UE simulator in which the functionalities of a UE (e.g., UE protocol stacks, etc.) may be disaggregated into multiple components such that the hardware resources may be allocated to the specific components according to the requirements (e.g., a UE simulator for mainly evaluating the L2 capacity of the DU may have an L2-simulator that simulates main L2 functionalities and a MUCE that simulates common functionalities, a UE simulator for mainly evaluating the L3 capacity of the DU may have an L3-simulator that simulates main L3 functionalities and a MUCE that simulates common functionalities, etc.). The disaggregated components of the UE simulator may be configured to perform dedicated operations (e.g., the L2-simulator may perform operations to simulate specific L2 functionalities, the MUCE may perform operations to simulate L3 functionalities, etc.). In addition, the simulated UE or the UE-context associated therewith may be distributed among the components of the UE simulator (e.g., among different threads in the L2-simulator, etc.) according to the requirements of the simulation to balance the load of the UE simulator. As a result, the efficiency and effectiveness in simulating the UE and managing the simulated UE may be improved.

In addition, example embodiments of the present disclosure may also implement a virtual L1-forwarder in the DU such that the DU may directly communicate with the UE simulator via the L1-forwarder, without requiring an RU. Accordingly, the number of simulated UEs supported by the UE simulator may not be restricted due to the limitations of the RU.

It is contemplated that features, advantages, and significances of example embodiments described hereinabove are merely a portion of the present disclosure and are not intended to be exhaustive or to limit the scope of the present disclosure. Further descriptions of the features, components, configuration, and operations of example embodiments are provided in the following.

### Example System Architecture and System Configuration

FIG. 1 illustrates a block diagram of an example system architecture 100, according to one or more example embodiments. As shown in FIG. 1, the system may include a UE-simulator 110, a distributed unit (DU) 120, a transaction/test automation controller (TAC) 130, a central unit (CU) 140, a core network 150, and a traffic generator 160.

The UE simulator 110 may be implemented in at least one server and/or a cloud-based environment. Alternatively or additionally, the UE simulator 110 may be implemented in the form of virtual machines (VMs) and/or containers. The UE simulator 110 may be configured to simulate or emulate one or more functionalities of one or more UEs. According to example embodiments, the UE simulator may be configured to simulate/emulate a UE instance that represents a virtual UE which is, from the perspective of the DU 120, similar to a physical/real UE. According to example embodiments, the UE simulator may be configured to simulate/emulate a specific functionality (e.g., a specific L2/L3 functionality, etc.) or protocol stack (e.g., L1, L2, and/or L3 protocols) of a UE. The UE simulator 110 may simulate/emulate operations associated with L1, L2, and/or L3 protocols, thereby enabling testing and evaluation of various DU's capacities.

The UE simulator 110 may be communicatively coupled to the TAC 130 and receive an input or instruction therefrom. Accordingly, the UE simulator 110 may perform the simulation/emulation based on the input or instruction provided by the TAC 130, and may provide the simulation/evaluation results to the TAC 130. Specifically, the TAC 130 may act as a controlling agent to control the end-to-end deployment or implementation of the UE simulation and DU capability evaluation. For instance, the TAC 130 may enable a user (e.g., a test engineer, a network operator, etc.) to specify or customize a test scenario or simulation requirement, such as the desired operations to be simulated (e.g., attach/detach operations, protocol data unit (PDU) session establishments, paging operations, etc.), determine the number of UEs, select specific functionalities (e.g., L2/L3 functionalities, etc.) that are intended to be simulated, specify test targets (e.g., target DU(s), target DU capacity(s) to be tested, etc.), and the like. According to example embodiments, the TAC 130 may be configured to output a user interface (UI), such as a graphical UI (GUI) that comprises interactive elements (e.g., a button, a text field, a drop-down list, etc.), a command-line interface (CLI), etc., which may, upon being interacted by the user, receives a user input for specifying the test scenario/simulation requirement. Additionally, the TAC 130 may also present the simulation/evaluation results to the user via the UI (e.g., visually via a graphical UI (GUI), etc.). The TAC 130 may be implemented as a software application that runs on a server, a VM, or in a cloud-based environment.

The UE simulator 110 may be communicatively coupled to the DU 120. For instance, the UE simulator 110 may be communicatively coupled to the L1 layer of the DU 120 (via the radio layer). Such configuration may be referred to herein as the “L1 mode”. By communicatively coupling the UE simulator 110 to the L1 layer of the DU 120, the evaluation of the L1 capacity of the DU 120 may be performed. Alternatively or additionally, the UE simulator 110 may communicatively couple to the L1-forwarder 121 of the DU 120 to bypass the L1 layer and focus specifically on L2/L3 evaluations of the DU 120. Such configuration may be referred to herein as the “L1-bypass mode”.

The DU 120 represents the component under evaluation and is primarily responsible for handling real-time and lower-layer processing tasks, such as L1 and L2 processing. In addition, the DU 120 also manages (e.g., process, transmit, etc.) L3 signals or messages between the UE simulator 110 and the CU 140. The DU 120 may be deployed closer to the edge, i.e., nearer to the cell sites and/or the end-users, thereby enabling low-latency communication therewith.

As illustrated in FIG. 1, the DU 120 may include the L1-forwarder 121 (or a component that implements the L1-forwarder 121) and a plurality of DU functionalities 122 (e.g., functionalities associated with various protocol stacks, such as L1, L2, and/or L3). The L1-forwarder 121 of the DU 120 may refer to a virtual/simulated L1 module that acts as a forwarder that forwards data or messages among the DU 120 and the UE simulator 110. The L1-forwarder 121 may be communicatively coupled to the DU functionalities 122 and may be configured to forward data/messages from the UE simulator 110 to the DU functionalities 122 and vice versa. According to example embodiments, the L1-forwarder 121 may include a light-weighted application that is coupled with L2 and/or L3 of the DU to preserve L2 and/or L3 functionalities as it is and forward the L2 and/or L3 packets directly to the UE simulator 110. In this regard, the L1-forwarder may communicate with the UE simulator 110 (or a simulator forwarder implemented therein) via, for example, an application programming interface (API).

The CU 140 is responsible for non-real-time and higher-layer processing tasks, such as L3 processing (e.g., Radio Resource Control (RRC) signaling, etc.). The CU 140 may interoperate with the DU 120 to support connection setup, mobility management, and handover procedures. The CU 140 may be deployed in a centralized data center or a regional server, thereby enabling centralized management (e.g., scaling, configuring, etc.) thereof. The CU 140 may communicatively couple the DU 120 and the UE simulator 110 to the core network 150.

The core network 150 is responsible for the overall network operations and connecting the RAN (e.g., DU 120, CU 140, etc.) and the end-users to the traffic generator 160. For instance, the core network 150 may be configured to provide overall connectivity management, user management, mobility management, policy management, and the like. According to example embodiments, the core network 150 may include an evolved packet core (EPC) in LTEand/or a 5G Core (5GC) in 5G.

The traffic generator 160 is communicatively coupled to the core network 150 and is responsible for generating downlink traffic and receiving uplink traffic to simulate real-world user data flow. According to example embodiments, the traffic generator 160 may include a real network service provider, such as an internet or intranet. Alternatively or additionally, the traffic generator 160 may be a dedicated component designed for the evaluation of the DU capacity.

It is contemplated that the configurations illustrated in FIG. 1 is simplified for descriptive purposes, and the scope of the present disclosure should not be limited thereto. Specifically, the system of the example embodiments may include more/less components and may be configured in a different manner than as illustrated.

FIG. 2A illustrates a block diagram of an example configuration 200 between the components of the UE simulator 110, the DU 120, and the TAC 130, according to one or more example embodiments.

As illustrated in FIG. 2A, the UE simulator 110 may include a simulator forwarder 111, an L2-simulator 112, and a multi-UE cell emulator (MUCE) 113. The MUCE 113 may also communicatively couple to the TAC 130. Further, the simulator forwarder 111 may refer to a simulated or virtual component that communicates with the L1-forwarder 121 of the DU 120, to thereby receive data/message from the DU 120 and transmit data/message to the DU 120. According to example embodiments, the simulator forwarder 111 may include a data plane development kit (DPDK)-based forwarder that receives and forwards packets from and to the DU 120. Further, when the simulator forwarder 111 is communicatively coupled to the L2-simulator, the simulator forwarder may also be referred to as an “L2-forwarder”. Furthermore, in some example embodiments, the simulator forwarder 111 may include at least two dedicated threads, one of which is dedicated to receiver-related operations and another one of which is dedicated to transceiver-related operations.

According to example embodiments, the UE simulator 110 may implement a split mode architecture for a UE with an embedded traffic generator, thereby enabling one or more customizable simulation operations (e.g., unique simulations for satisfying specific requirements, etc.). In some example embodiments, the UE simulator 110 may be configured to implement the split mode based on signaling and network traffic/data. Alternatively or additionally, UE simulator 110 may be configured to implement the split mode based on real-time and non-real-time functionalities. Alternatively or additionally, the UE simulator 110 may be configured to implement the split mode by splitting UE stacks across multiple applications. The non-access stratum (NAS)/RRC packet data convergence protocol (PDCP) signaling may be implemented by or simulated in the MUCE 113, the complete L2 MAC and/or radio link control (RLC) protocol functionalities may be implemented by or as a part of the L2-simulator 112, and the traffic generator may be embedded into or implemented by the L2-simulator 112 for ULtraffic generation/simulation.

As a non-limiting example, in some example embodiments, the L2-simulator 112 may implement or simulate the L2 functionalities (or at least some specific L2 functionalities), while the MUCE 113 may implement or simulate other common functionalities (e.g., L3 functionalities, part of L2 functionalities, etc.). According to example embodiments, the L2-simulator 112 and the MUCE 113 may be configured to split one or more UE protocol stacks and may each implement one or more split functionalities. For instance, the L2-simulator 112 may be configured to implement a portion of PDCP functionalities (e.g., signaling-related functionalities, etc.), while the MUCE 113 may be configured to implement another portion of the PDCP functionalities (e.g., data-related functionalities, etc.).

FIG. 2B illustrates a block diagram of another example configuration 210 between the components of the UE simulator 110, the DU 120, and the TAC 130, according to one or more example embodiments.

In the example configuration 210, the simulator forwarder 111 (e.g., a DPDK-based forwarder) may be implemented or integrated as a part of the L2-simulator 112. Accordingly, the L2-simulator 112 may directly communicate with the L1-forwarder 121 of the DU 120, without requiring an additional step/operation for data reception and forwarding.

FIG. 3A illustrates a block diagram of an example system configuration 300 for evaluating the L2 capacity of the DU, according to one or more example embodiments. In this example use case, the L2-forwarder 111 is implemented externally or separately from the L2-simulator 112, the L2-simulator 112 is configured to implement or simulate MAC protocol functionalities, RLC protocol functionalities, and a portion of PDCP functionalities, (i.e., part of L2 functionalities), and the MUCE 113 is configured to implement or simulate another portion of the PDCP functionalities (i.e., another part of L2 functionalities), RRC protocol functionalities (i.e., L3 functionalities), NAS protocol functionalities, general application (labeled as “MUCE APP” in FIG. 3) such as application for interacting with the TAC 130, and an interface for coupling to the L2-simulator 112 (labeled as “MUCE L2SIM IFC” in FIG. 3). It is contemplated that the implementation illustrated in FIG. 3A is merely an example and the scope of the present disclosure should not be limited thereto. Specifically, in some example embodiments, the L2-simulator 112 and/or the MUCE 113 may implement or simulate any other suitable L2 functionalities (e.g., the L2-simulator 112 may implement/simulate a portion of the RLC functionalities and the MUCE 113 may implement/simulate another portion of the RLC functionalities, etc.), the MUCE 113 may simply implement a dummy Layer 2 that act as the L2-forwarder, and the like, without departing from the scope of the present disclosure. In addition, as further described below with reference to FIG. 3B, the L2-forwarder 111 may also be implemented or integrated as a part of the L2-simulator 112.

As illustrated in FIG. 3A, the L2-forwarder 111 may be communicatively coupled to the L1-forwarder 121 of the DU 120 (the L1-forwarder 121 may be part of L1-applications implemented in the DU). Within the DU 120, the L1-forwarder 121 may be communicatively coupled to the L2 functionalities 122 via a logical link control (LLC) layer. Further, the L1-forwarder 121 may also be communicatively coupled to a timing manager 133 (labeled as “TIMING-MGR” in FIG. 3A). The timing manager 113 may be configured to maintain synchronization and timing accuracy of the L1-forwarder 121, thereby ensuring that the L1-forwarder 121 is accurately synchronized with the UE simulator 110 and enabling correct transmission/reception of data and signals at the appropriate time.

As also illustrated in FIG. 3A, the DU 120 may communicate with other components via various interfaces. For instance, the DU 120 may communicate with the CU 140 via the F1 application protocol (F1AP) interface, the F1 control plane (F1C) interface and/or the F1 user plane (F1U) interface, and may communicate with downstream components (e.g., UE simulator 110, etc.) via the RLC interface, the MAC interface, and/or the Stub physical layer (Stub-PHY) interface.

Similarly, the CU 140 may communicate with other components via various interfaces. For instance, the CU 140 may communicate with the core network (e.g., 5GC 150) via a next-generation application protocol (NGAP) interface and/or a GPRS tunneling protocol (GTP) interface, may communicate with the DU 120 via the F1U interface, the F1C interface, the X2 user plane (X2U) interface, and/or the X2 control plane (X2C) interface, and may communicate with a RAN intelligent controller (RIC) of the RAN via the E2 Application Protocol (E2AP) interface.

Further, the 5 GC 150 may communicate with other components via various interfaces. For instance, the 5GC 150 may communicate with the CU 140 via the NGAP interface and/or the GTP interface, and may communicate with the traffic generator 160 via a service gateway interface (SGI).

FIG. 3B illustrates a block diagram of another example system configuration 310 for evaluating the L2 capacity of the DU, according to one or more example embodiments. In this example use case, the L2-forwarder is implemented or integrated as a part of the L2-simulator 112. Accordingly, the L2-simulator 112 may directly communicate with the L1-forwarder 121 of the DU 120, without requiring an additional step/operation for data reception and forwarding.

It is contemplated that the example configurations in FIG. 3A and FIG. 3B are merely examples and the configuration of the system may vary according to the requirements. For instance, in another example use case for evaluating L3 capacity of the DU, the “L2 simulator” may be replaced with a component (e.g., an “L3 simulator” or a component with any other suitable labeling) that implements and simulate one or more L3 functionalities, the “L2-forwarder” may be replaced with a component (e.g., an “L3-forwarder” or a component with any other suitable labeling) that receives and forwards data or messages between the DU and the simulator, the MUCE 113 may implement the L2 functionalities (e.g., RLC, MAC, PDCP) and common functionalities, the “L2 functionalities” in the DU may be replaced with “L3 functionalities” (or functionalities with any other suitable labeling), and the like, without departing from the scope of the present disclosure.

FIG. 4 illustrates a block diagram of example configurations 400 between components of the L2-simulator and other components, according to one or more example embodiments.

As illustrated in FIG. 4, the L2-simulator 112 may include a simulator interface 112-1, a plurality of non-real-time (NRT) threads 112-2, a plurality of real-time (RT) threads 112-3, a UE repository 112-4, and a job pool 112-5, each of which may be interconnected (or communicatively coupled) to one another.

The simulator interface 112-1 may be configured to communicatively couple other components of the UE simulator 110 (e.g., simulator forwarder 111, MUCE 113) and components external to the UE simulator 110 (e.g., TAC 130) to the components of the L2-simulator 112. According to example embodiments, the simulator interface 112-1 may include a plurality of interfaces, each of which is dedicated to communicatively coupling a specific component to the components of the L2-simulator 112. For instance, as illustrated in FIG. 5, the simulator interface 112-1 may include a simulator physical interface 112-4 (labeled as “Sim PHY” in FIG. 5) that communicatively coupled the DU 120 and/or the simulator forwarder 111 to the components of the L2-simulator 112, a MUCE interface 112-5 (labeled as “MUCE INTF” in FIG. 5) that communicatively coupled the MUCE 113 to the components of the L2-simulator 112, and a traffic generator 112-6 that communicatively coupled the TAC 130 to the components of the L2-simulator 112. Further, in some example embodiments, the simulator forwarder 111 may be implemented or integrated as a part of the simulator interface 112-1. In that case, the DU 120 (or the L1-forwarder implemented therein) may directly communicate with the L2-simulator 112 via the simulator interface 112-1.

Referring back to FIG. 4, the NRT threads 112-2 may be configured to perform or manage non-real-time operations. According to example embodiments the L2-simulator 112 may include at least 2 NRT threads that are responsible for operations or tasks that are not related (or have a low priority) to the simulated UE(s) (may be referred to as “non-UE works” herein). The non-UE works may include, for example, cell-related tasks/operations (e.g., management of master information block (MIB) and system information block (SIB), etc.), management of MAC protocol state, communication with upper layer protocols, and the like.

Further, as illustrated in FIG. 5, each of the NRT threads 112-2 may include an NRT queue and a worker node. The NRT queue may refer to a buffer where the associated tasks or data are temporarily stored for a predetermined amount of time, while the worker node may refer to the component (e.g., a processing unit, etc.) responsible for executing the tasks. In the example of FIG. 5, the NRT threads are configured to receive data (e.g., from the DU 120, from the MUCE 113, from the TAC 130, from the RT threads 112-3, etc.) and process the received data, thus the associated NRT queue may be labeled as “NRT Rx-Q” and the associated worker node may be labeled as “Rx-Worker”. According to example embodiments, the NRT queues of the NRT threads 112-2 may be implemented in the form of circular buffers or lockless/lock-free ring buffers and may be managed by a ring manager, thereby enabling the enqueuing and dequeuing of data or packets in a first-in-first-out (FIFO) manner and improving the queue efficiency.

On the other hand, the RT threads 112-3 may be configured to perform or manage real-time operations. According to example embodiments the L2-simulator 112 may include at least 4 NRT threads that are responsible for operations or tasks that are related (or have high priority) to the simulated UE(s) (may be referred to as “UE-related works” herein). The UE-related works may include, for example, creating the UE-context of a simulated UEbased on a requirement (e.g., provided by the user via the TAC 130), mapping the UE-context against the associated radio network temporary identifier (RNTI), storing the UE-context and the mapping to the UE repository 112-4, creating a job associated with the UE and transmitting the job to the job pool 112-5, and the like. According to example embodiments, the RT threads 112-3 may be configured to execute tasks or jobs per transmission time interval (TTI) as scheduled in the job pool 112-5. For instance, at every TTI, the RT threads 112-3 may access the job pool 112-5 and execute one or more tasks/jobs in the job pool 112-5.

As illustrated in FIG. 5, similar to the NRT threads 112-2, each of the RT threads 112-3 may include an RT queue and a worker node. The RT queue may refer to a buffer where the associated tasks or data are temporarily stored for a predetermined amount of time, while the worker node may refer to the component (e.g., a processing unit, etc.) responsible for executing the tasks. In the example of FIG. 5, the RT threads are configured to receive data (e.g., from the DU, from the MUCE 113 via the NRT threads 112-2, from the TAC 130 via the NRT threads 112-2, etc.) and process the received data, thus the associated RT queue may be labeled as “RT Rx-Q” and the associated worker node may be labeled as “Rx-Worker”. According to example embodiments, the RT queues of the RT threads 112-3 may be implemented in the form of circular buffers or lockless/lock-free ring buffers and may be managed by a ring manager, thereby enabling the enqueuing and dequeuing of data or packets in a FIFOmanner and improving the queue efficiency.

According to example embodiments, the L2-simulator 112 may be configured to simulate a UE (e.g., by generating UE-context associated therewith) and then distribute the UE (or the loads and/or UE-context associated therewith) among the NRT threads 112-2 and RT threads 112-3. For instance, general tasks/operations (e.g., receiving from the MUCE 113 a request for creating specific UE-context, sending to the MUCE 113 a request to generate an L3 message, etc.) may be distributed among the NRT threads 112-2, while the UE-specific tasks/operations (e.g., creating the UE-context, managing the UE-context, creating a job to send an L3 message, etc.) may be distributed among the RT threads 112-3.

In some example embodiment, the L2-simulator 112 may be configured to distribute the UE (or the associated UE-context) to a first RT thread based on a random access RNTI (RA-RNTI) associated with the UE, and then distributed the UE (or the associated UE-context) to a second RT thread based on a cell RNTI (C-RNTI) associated with the UE. The RA-RNTI may be created and provided to the L2-simulator 112 by the MUCE 113, while the C-RNTI may be created and provided to the L2-simulator 112 by the DU 120. Further descriptions associated therewith are provided below with reference to the non-limiting example use case in FIGS. 6A-6D.

According to example embodiments, the L2-simulator 112 may be configured to simulate multiple UEsand then distribute the UEs(or the loads/UE-contexts associated therewith) among the NRT threads 112-2 and RT threads 112-3. As described above, the UEsmay be distributed based on the associated RA-RNTI and C-RNTI. Accordingly, the number of UEsthat can be simulated can be efficiently and effectively managed (e.g., scale-up, scale-down, etc.) by configuring the number of NRT threads 112-2 and RT threads 112-3. According to example embodiments, the L2-simulator may include a controller that contains multiple computing cores, each of which may be configured to manage a dedicated thread of the NRT threads 112-2 and RT threads 112-3

Referring still to FIG. 4, the UE repository 112-4 may be communicatively coupled to the NRT threads 112-2 and RT threads 112-3. The UE repository 112-4 may include a storage medium (e.g., a database, an in-memory storage, etc.) that stores the UE-context (generated or provided by the RT threads 112-3, etc.) associated with the simulated UE. The UE-context may include, for example, identifiers of the simulated UE (e.g., RA-RNTI, C-RNTI, etc.), security information (e.g., authentication token, etc.), radio bearer information (e.g., bearer type, priority level, quality of service (QoS) requirements, etc.), mobility information (e.g., handover parameters, etc.), and the like. In some example embodiments, the UE-context may include protocol-specific context, such as MAC context associated with the MAC layer of the protocol stack of the UE (e.g., logical channel information, Hybrid Automatic Repeat Request (HARQ) information, resource allocation information, channel quality indicator (CQI) information, random access procedure information, etc.), RLC context associated with the RLC layer of the protocol stack of the UE (e.g., RLC modes information, sequence number (SN) information, RLC buffer information, status report information, etc.), and the like. According to example embodiments, the UE repository 112-4 may also store a mapping of the UE-context and the associated RA-RNTI/C-RNTI. It is contemplated that the UE repository 112-4 may include or store any other suitable information that are associated with the UE, without departing from the scope of the present disclosure.

The job pool 112-5 may be communicatively coupled to the NRT threads 112-2 and RT threads 112-3. The job pool 112-5 may include a queue, a buffer, or any other suitable data structure that stores (for at least a period of time) events or jobs that need to be executed. According to example embodiments, the job pool 112-5 may store or manage the events/jobs according to the associated time slot(s). For instance, the job pool 112-5 may interoperate with a scheduler that allocate a time slot (and/or any other suitable radio resources) to the simulated UE. Accordingly, the job pool 112-5 may store or hold the events/jobs of the simulated UE in the associated time slot. Subsequently, upon receiving a slot indication of the time slot, the RT threads 112-3 may traverse the job pool 112-5 and execute the associated events/jobs thereafter. According to example embodiments, the job pool 112-5 may include multiple job pools (or multiple partitions) each of which may be dedicated to an RT thread and/or an NRT thread.

It is contemplated that the configuration in FIG. 4 is merely an example embodiment and the scope of the present disclosure should not be limited thereto. Specifically, the L2-simulator 112 may include more/less components than as illustrated, and/or may be configured in a different manner than as illustrated. For instance, FIG. 5 illustrates a non-limiting example configuration 500, in which the L2-simulator 112 includes additional components that interoperate with each other and the external components, according to one or more example embodiments.

The L2-simulator 112 in FIG. 5 includes components that enable the UE simulator to operate in both the L1-bypass mode (where the UE simulator is communicatively coupled to the L1-forwarder of the DU without connecting through the physical L1 layer of the DU) and the L1 mode (where the UE simulator is communicatively coupled to the L1 layer of the DU). Further, the L2-simulator 112 in FIG. 5 is configured to mainly focus on the simulation of the UE MAC-layer processes or functionalities. As illustrated in FIG. 5, in addition to the components described above with reference to FIG. 4 (i.e., NRT threads 112-2, RT-threads 112-3, UE repository 112-4, job pool 112-5), the L2-simulator 112 may further include components such as: an L2-simulator controller 112-0, a simulator physical layer interface 112-6, a MUCE interface 112-7, a traffic generator 112-8, an RLC-simulator 112-9, an event processing engine 112-10, a MAC scheduler 112-11, a parser 112-12, a TTI generator 112-13, an RT timer 112-14, a service data adaptation protocol (SDAP) module 112-15, a PDCP module 112-16, and a plurality of transmitter queues 112-17.

One or more components of the L2-simulator 112 illustrated in FIG. 5 may be implemented in the software form (e.g., virtualized, containerized, etc.) and may be stored within a storage medium associated with the UE simulator. In this case, whenever the L2-simulator 112 is activated or boot-up, the L2-simulator controller 112-0 may access the storage medium to obtain the associated data/files, and then execute the data/files to thereby initialize and activate the component(s) of the L2-simulator 112. For instance, the L2-simulator controller 112-0 may perform a power-on self-test (POST) to check if all essential hardware components or resources required for the component(s) are functioning normally before initializing the component(s), load the required software components (e.g., firmware, hypervisor, operating system, etc.), allocate/partition resources (e.g., CPU, GPU, memory, network bandwidth, etc.), execute virtual machines (VMs)/containers, apply system configurations/policies, and the like, thereby initializing and activating the component(s) of the L2-simulator 112. Further, the L2-simulator controller 112-0 may also perform one or more operations to manage the component(s) of the L2-simulator 112, such as one or more Fault, Configuration, Accounting, Performance, and Security (FCAPS) management operations.

The TAC 130 may act as a controlling agent to control the end-to-end deployment or implementation of the UE simulation and DU capability evaluation. Generally, a user (e.g., a network operator, a test engineer, etc.) may specify a test scenario or simulation requirement via the TAC 130. Accordingly, the TAC 130 may communicate with the MUCE 113 (via an API, etc.) to provide information associated with the test scenario/simulation requirement to the MUCE 113. The MUCE 113 may determine whether the test scenario/simulation requirement involves operation(s) associated with the L2-simulator 112. Based on determining that the test scenario/simulation requirement involves operation(s) associated with the L2-simulator 112 (e.g., the test scenario/simulation requirement involves an L2 operation, etc.), the MUCE 113 may communicate with the L2-simulator 112 via the MUCE interface 112-7.

As a non-limiting example, it may be assumed that the user has specified, via the TAC 130, a test scenario/simulation requirement to simulate an attach operation to thereby evaluate the L2 and L3 capacities of the DU 120 during the attach operation. In this case, the TAC 130 may push the specified test scenario/simulation requirement to the MUCE 113, and the MUCE 113 may simulate L3-related processes (e. g, NAS-layer process, RRC-layer process, etc.) and may then determine that an L2-related process, such as a random access channel (RACH) process (which is a MAC-layer procedure that primarily involves L2-simulator) is required in the attach operation. Accordingly, the MUCE 113 may provide the associated information (e.g., a RACH event, a UE ID, a RACH request, an RA-RNTI, etc.) to the L2-simulator 112 via the MUCE interface 112-7. In this regard, since the RACH process is primarily a MAC-layer procedure, the information provided by the MUCE 113 may simply pass through the RLC-simulator 112-9 (e.g., the RLC-simulator 112-9 may determine that the information provided by the MUCE does not require or involve RLC-related simulation and may thus push the information to the further component, the MUCE 113 may identify a target component in the L2-simulator and the MUCE interface 112-7 may simply forward the information to the target component, etc.). According to example embodiments, the RACH-related information may pass through several components (e.g., MAC scheduler 112-11, etc.) and ultimately arrive at one of the NRT threads 112-2. Subsequently, the NRT thread 112-2 may determine which of the RT threads 112-3 can handle the RACH-related information and then push the RACH-related information thereto. Alternatively or additionally, the RACH-related information may also be pushed (e.g., by the RLC-simulator 112-9, etc.) to at least one of the RT threads 112-3. Further descriptions associated with the example use case of the RACH process are provided below with reference to FIGS. 6A-6D.

According to example embodiments where the simulation of the RLC-layer process is required or involved, the RLC-simulator 112-9 may be configured to simulate the required process within the RLC entity. The RLC entity may include threads and queues for executing the simulation or the related tasks/jobs in an appropriate sequential manner. The RLC-simulator 112-9 may also utilize one or more RLC protocols during the simulation of the RLC-layer process.

The event processing engine 112-10 may receive events (e.g., RACH event, etc.) from the NRT threads 112-2 and/or the RT threads 112-3, and then process the events thereafter. For instance, upon receiving the events, the event processing engine 112-10 may process the events to determine whether the events need to be scheduled, need to be supplemented with additional information (e.g., MAC protocols, etc.), need to be provided to further components (e.g., the RLC-simulator 112-9, the MUCE 113, the DU 120, etc.). In this regard, based on determining that the events need to be scheduled, the event processing engine 112-10 may push the events to the MAC scheduler 112-11. Further, based on determining that the events need to be supplemented with additional information, the event processing engine 112-10 may supplement the events accordingly (e.g., generate the supplemental information based on the MAC protocols, communicate with other components to obtain the supplemental information, etc.). Furthermore, based on determining that the events need to be provided to further components, the event processing engine 112-10 may push the events to the associated components (e.g., push the events to the MUCE interface 112-7 such that the events may be forwarded to the MUCE 113, push the events to the transmitter queues 112-17 such that the events may be transmitted to the DU 120, etc.).

The MAC scheduler 112-11 may be configured to manage and schedule the tasks/jobs in the job pool 112-5. According to example embodiments, the MAC scheduler 112-11 may manage a job list of the job pool 112-5 to ensure that the load of each of the NRT threads 112-2 and RT threads 112-3 are optimized. For instance, the MAC scheduler 112-11 may be configured to schedule tasks/jobs for each TTI, so as to ensure that the tasks/jobs to be executed in each TTI do not exceed a predetermined threshold (e.g., a maximum of 4 tasks/jobs in each TTI, etc.). In case the number of tasks/jobs to be scheduled exceeds the predetermined threshold, the MAC scheduler 112-11 may schedule the tasks/jobs for the subsequent TTIs. As a non-limiting example, assuming there are 8 tasks/jobs to be scheduled and the predetermined threshold is a maximum of 4 tasks/jobs in each TTI, the MAC scheduler 112-11 may schedule the first 4 tasks/jobs that arrive earlier at the MAC scheduler 112-11 for the first TTI and then schedule the remaining 4 tasks/jobs that arrives later for the subsequent TTI. Alternatively, the MAC scheduler 112-11 may schedule 4 tasks/jobs that have higher priority (the priority level may be defined by the user, etc.) for the first TTI and then schedule the other 4 tasks/jobs that have lower priority for the subsequent TTI. According to example embodiments, the MAC scheduler 112-11 may be configured to reschedule the tasks/jobs based on the associated priority. For instance, whenever the MAC scheduler 112-11 receives a new task/job, the MAC scheduler 112-11 may compare the priority of the new task/job with the priority of the scheduled tasks/jobs, and then reschedule the tasks/jobs accordingly when required. Further, according to example embodiments where the UE simulator is configured to simulate multiple UEs, the MAC scheduler 112-11 may schedule tasks/jobs for the multiple UEs, based on the priority of the UEs, and the like.

The parser 112-12 may be configured to receive information from the MAC scheduler 112-11 and simulate L1-payload based thereon. For instance, whenever the tasks/jobs involve L1-operation, the parser 112-12 may process the associated information to ensure that the information is L1-compatible. As a non-limiting example, assuming that a task involve an L1-message, the parser 112-12 may process the message to ensure that it is L1-compatible.

The transmitter queues 112-17 may be configured to receive data or information to be transmitted to the simulator forwarder 111 and/or the DU 120, and then buffer the data or information therein. Accordingly, the transmitter queues 112-17 may provide the buffered data/information to the simulator physical layer interface 112-6 in a sequential manner, such that the simulator physical layer interface 112-6 may transmit the data/information to the simulator forwarder 111 and/or the DU 120 in the sequential manner.

The traffic generator module 112-8, SDAP module 112-15, and PDCP module 112-16 may interoperate to simulate uplink data traffic. In this regard, the traffic generator module 112, upon receiving from the TAC 130 a request for simulating uplink data traffic, may generate uplink data packets that simulate application-level uplink traffic and then provide the same to the SDAP module 112-15. The SDAP module 112-15 may be configured to map the uplink data packets to appropriate QoS flows and add SDAP headers to the data packets to indicate the associated QoS flow. Accordingly, the SDAP module 112-15 may provide the QoS-mapped packets to the PDCP module 112-18. The PDCP module 112-18 may perform operations such as encrypting the data packets provided by the SDAP module 112-15, adding sequence numbers for packet ordering and delivery assurance, and the like. After the PDCP processing, the data packets may be further processed by lower-layer protocols and then transmitted to the DU 120. For instance, the PDCP module 112-18 may provide the processed data packets to the RLC simulator 112-9 for RLC-layer processing (e.g., segmentation, etc.), the RLC simulator 112-9 may provide the processed data packets to the further components (e.g., event processing engine 112-10, MAC scheduler 112-11, etc.) for MAC-layer processing (e.g., scheduling, etc.), and the like. Ultimately, the data packets may be transmitted by the simulator physical layer interface 112-6 to the simulator forwarder 111 and/or the DU 120, thereby simulating uplink data traffic that is originated from the simulated UE.

The TTI generator 112-13 and RT timer 112-14 are implemented to compensate or supplement scenarios when the UE simulator operates under the L1 mode and/or when the DU 120 is not able to generate/provide TTI information to the L2-simulator 112. For instance, when the UE simulator operates under the L1-bypass mode, the L1-forwarder of the DU 120 is responsible for generating and providing TTI information to the L2-simulator. In this regard, when the UE simulator operates under the L1 mode (i.e., the L1-forwarder is not involved) or when the DU 120 is not able to generate/provide the TTI information (e.g., the L1-forwarder experiences failure, the DU 120 does not have an L1-forwarder implemented, etc.), the TTI generate 112-13 may be configured to generate TTI information on behalf of the DU 120 during the simulation. Accordingly, the RT timer 112-14 may be configured to provide the real-time functionality required to simulate time progression in the UE simulator. For instance, the RT timer 112-14 may act as the time reference for the TTI generator 112-13 to ensure that the TTI generator 112-13 may generate precise and accurate TTI information. According to example embodiments, the RT timer 112-14 may be communicatively coupled to a timing module 170.

The timing module 170 may include a precision time protocol (PTP)-based timing module, a global positioning system (GPS)-based timing module, and any other suitable type of timing module, that is communicatively coupled to the L2-simulator 112 and the DU 120 and provide timing information thereto, thereby ensuring high precision synchronization between the L2-simulator 112 and the Du 120

The simulator physical layer interface 112-6, MUCE interface 112-7, and traffic generator 112-8 are examples of simulator interface 112-1 (in the system configuration 400 of FIG. 4), since each of these components communicatively couple the components of the L2-simulator 112 to components external to the L2-simulator 112. The communications therebetween may be performed in the form of API calls among the interfaces.

It is contemplated that the configuration in FIG. 5 is merely an example configuration and the scope of the present disclosure should not be limited thereto. For instance, in some example implementations, the event processing engine 112-10 may directly communicate with the MUCE 113 (via the MUCE interface 112-7), without communicating with the RLC simulator 112-9 (e.g., when the event is not related to RLC or is not required any operation from the RLC simulator 112-9, etc.), the traffic generator 112-8, SDAP module 112-15, and PDCP module 112-16 may be replaced with a consolidated module/component that may be configured to generate uplink data, the job pool 112-5 may be implemented separately from the MAC scheduler 112-11, the simulator forwarder 111 may be implemented or integrated as a part of (or may simply replace) the simulator physical layer interface 112-6, and the like, without departing from the scope of the present disclosure.

### Example Use Case

A non-limiting example use case of the simulation of a UE and the distribution of a simulated UE in the UE simulator is described below with reference to the flow diagrams in FIGS. 6A-6D. In this example use case, it may be assumed that the UE simulator is configured to simulate a UE to evaluate the capacity of the DU via a random access channel (RACH) process.

At operation 1, the MUCE 113 may be configured to generate a RACH request and an RA-RNTI and transmit them to the L2-simulator 112. According to example embodiments, the MUCE 113 may be configured to generate the RACH request and the RA-RNTI based on data or instructions provided by the TAC 130. Additionally or alternatively, the MUCE 113 may also generate the RACH request and the RA-RNTI based on data or instructions provided by the DU 120. For instance, the DU 120 may periodically broadcast information (e.g., system information block (SIB1), etc.) to the UE simulator 110 (via the L1-forwarder 121, etc.), such as information associated with cell identity, system time, available random access resources, random access parameters/configurations, and the like. Such information may be provided to the MUCE 113, and may be utilized by the MUCE 113 to generate the RACH request and the RA-RNTI whenever the MUCE 113 determines that a RACH procedure should be triggered (e.g., based on receiving a request for initiating the RACH procedure from the TAC 130, etc.). In some example embodiments, instead of generating the RA-RNTI and providing the same to the L2-simulator 112, the MUCE 113 may provide the information required for generating the RA-RNTI (e.g., a UE ID, etc.) to the L2-simulator 112, and the L2-simulator 112 may generate the RA-RNTI based on the provided information.

At operation 2, an NRT thread (i.e., NRT thread 2 in this example use case) may pick up the RACH request and RA-RNTI and then push a RACH event to a first RT thread (i.e., RT thread 3 in this example use case). According to example embodiments, upon receiving the RACH request and RA-RNTI from the MUCE 113, the simulator interface 112-1 may randomly forward the received data/information to any of the available NRT threads. Alternatively, the simulator interface 112-1 may determine the load and/or status of each NRT thread (e.g., data held by the associated NRT queue, jobs pending in the associated job pool, etc.) and assign the RACH request and RA-RNTI to an appropriate NRT thread. Upon receiving the RACH request and RA-RNTI, the NRT thread may determine that a RACH event should be triggered and UE-related work (e.g., creation of UE-context, etc.) is required. Accordingly, the NRT thread may push the RACH event (along with the RACH request and RA-RNTI) to the RT thread. According to example embodiments, the NRT thread may randomly push the RACH event to any of the available RT threads. Alternatively, the NRT thread may determine the load and/or status of each RT thread (e.g., data held by the associated RT queue, jobs pending in the associated job pool, etc.) and push the RACH event to an appropriate RT thread. According to example embodiments, each of the RT threads (or the associated RT-queue) may be associated with one or more RA-RNTIs, and the NRT thread may push the RACH event to the RT thread that is associated with the received RA-RNTI. For instance, in the example of FIG. 6A, the Rx Queue 3 may be associated with RA-RNTI X, thus the NRT thread 2 (which received the RACH request and RA-RNTI X from the MUCE 113) may push the RACH event to the Rx Queue 3.

At operation 3, upon receiving the RACH event, the RT thread may create the UE-context and map it against the RA-RNTI for future reference. Subsequently, at operation 4, the RT thread may push an RACH event in the associated job pool. According to example embodiments, the RT thread may push the RACH event in the associated job pool for a calculated and/or available slot.

Referring to FIG. 6B, at operation 5, the RT thread may receive a slot indication associated with the slot in which the RACH event is stored in the job pool. The slot indication may be provided by the DU 120 as per transmission time interval (TTI). Upon receiving the slot indication, the RT thread may access the job pool and execute the job/event in the associated slot (i.e., the RACH event in this example). Accordingly, at operation 6, the RT thread may send the RACH request and the RA-RNTI to the DU 120.

Referring to FIG. 6C, at operation 7, the L2-simulator 112 may receive a RACH/Random Access Response (RAR) from the DU 120. The RAR may include the RA-RNTI and a C-RNTI generated by the DU 120. In addition, the RAR may also include information such as timing advance, an uplink resource grant, and the like. Upon receiving the RAR, at operation 8, the simulator interface (i.e., the simulator physical interface in this example) may post the event to the associated RT thread. This thread has the UE-context corresponding to the RA-RNTI in the associated local map.

Referring to FIG. 6D, at operation 9, the RT thread may decode the RAR to obtain the C-RNTI. Accordingly at operation 10, the RT thread may send an event to a second RT thread (i.e., RT thread 1 in this example) based on the C-RNTI. The event may include information associated with the UE (e.g., the UE-context, the mapping, etc.), the RAR, and the like. The RT thread may then remove the UE-context and the associated mapping. At operation 11, the second RT thread may process the RAR and create a new UE-context. Subsequently, at operation 12, the second RT thread may map the new UE-context against the C-RNTI. At operation 13, the second RT thread may post an event of creating a message 3 (Msg3) to the NRT thread. At operation 14, the second RT thread may push a job to send the Msg3 at a timing k2 (e.g., based on the RAR, etc.). Accordingly, at operation 15, the NRT thread may instruct the MUCE 113 to create the Msg3 and then send the Msg3 to the DU 120.

In view of the above, the UE simulator may be configured to simulate a UE that interacts with the DU 120 during a RACH process. The L2 capacity of the DU (i.e., in this example use case, the MAC capacity of the DU 120 in the RACH process) may be evaluated based thereon.

### Example Operations

Example operations for managing (e.g., simulating, distributing, etc.) simulated UE for DU capacity evaluation, according to one or more example embodiments, are described in the following. One or more operations described herein may be performed by a device (e.g., a server, etc.) that implements one or more components (e.g., UE simulator, etc.) and/or one or more example use cases of the example embodiments. For instance, the operation(s) may be performed by a processor of the device, upon executing computer-readable instructions or computer-executable instructions stored in a storage or memory of the device. Further descriptions of an example device are provided below with reference to FIG. 9.

FIG. 7 illustrates a flow diagram of an example method 700 for managing a UE for DU capacity evaluation, according to one or more example embodiments. One or more operations of method 700 may involve one or more features/components described above with reference to FIGS. 1-6D. For instance, the operation(s) may be performed by the device that implements the UE simulator 110 (and the components associated therewith, such as the L2-simulator 112, the MUCE 113, etc.). Thus, redundant descriptions associated therewith may be omitted below for conciseness.

For description purposes, it may be assumed that one or more operations of method 700 may be performed by a UE simulator (or a processor that implements the UE simulator) that includes an L2-simulator and a MUCE. As described above, the L2-simulator may be communicatively coupled to the MUCE and an L1-forwarder of a DU of a telecommunication system. Further, as described above, the MUCE may be communicatively coupled to the L2-simulator and a TAC configured to receive a simulation requirement from a user. In some example embodiments, the UE simulator may further include a simulator forwarder (e.g., an L2-forwarder, etc.) that may be communicatively coupled to the L2-simulator and the L1-forwarder of the DU.

Referring to FIG. 7, at operation S710, the UE simulator (or the associated processor) may be configured to receive data. For instance, at this operation, the L2-simulator of the UE simulator may receive a first data from the L1-fowarder of the DU and receive a second data from the MUCE. Further, the MUCE of the UE simulator may receive the first data from the L2-simulator and the simulation requirement from the TAC. According to example embodiments where the UE simulator includes the simulator forwarder, at this operation, the simulator forwarder may be configured to receive the first data from the L1-forwarder of the DU and receive the second data from the L2-simulator.

At operation S720, the UE simulator (or the associated processor) may be configured to forward the received data. For instance, at this operation, the L2-simulator may be configured to forward the first data to the MUCE and forward the second data to the L1-forwarder of the DU. According to example embodiments where the UE simulator includes the simulator forwarder, at this operation, the simulator forwarder may be configured to forward the first data to the L2-simulator (and the L2-simulator may then forward the first data to the MUCE) and forward the second data to the L1-forwarder of the DU.

At operation S730, the UE simulator (or the associated processor) may be configured to simulate functionalities of a UE. According to example embodiments, the L2-simulator of the UE simulator may simulate, based on the first data and/or the second data, one or more L2 functionalities of the UE. On the other hand, the MUCE of the UE simulator may simulate, based on the first data and/or the simulation requirement, one or more L3 functionalities of the UE. In some example embodiments, the L2-simulator may be configured to simulate a portion of packet data convergence protocol (PDCP) functionalities and the MUCE may be configured to simulate another portion of the PDCP functionalities.

According to example embodiments, the L2-simulator may be configured to simulate the L2 functionalities of the UE by: creating, based on the first data and/or the second data, UE-context associated with the UE; and simulating, based on the UE-context and at least one L2 protocol, data transmission to and data reception from the L1-forwarder of the DU.

The specific order of data reception, data forwarding, and data simulation, as well as the types of data involved therein, may vary according to the specific test scenario and/or simulation requirement. For instance, in the example use case of an attach operation simulation, the MUCE 113 may simulate, based on the data received from the TAC (e.g., test scenario/simulation requirement and data received from the DU such as the network configuration, bearer configuration, and cell information, etc.), the L3 functionalities involved in the attach operation (e.g., NAS-layer functionalities, RRC-layer functionalities, etc.), while the L2-simulator may simulate, based on the data received from the MUCE 113 (e.g., RACH request, RA-RNTI, etc.) and data received from the DU (e.g., C-RNTI, etc.), the L2 functionalities involved in the attach operation (e.g., MAC-layer functionalities, etc.).

According to example embodiments where the L2-simulator is configured to simulate the L2 functionalities of a RACH process during an attach operation, the L2-simulator may be configured to distribute the UE-context to a first RT thread based on an RA-RNTI, and then distribute the UE-context to a second RT thread based on a C-RNTI. In this regard, the L2-simulator may be configured to receive the RA-RNTI from the MUCE and receive the C-RNTI from the DU. Alternatively, the first RT thread may be configured to generate, based on a UE ID received from the MUCE, the RA-RNTI.

According to example embodiments where the L2-simulator further includes a plurality of NRT threads and a job pool, the L2-simulator may be configured to distribute the UE context to the first RT thread by: receiving, by at least one NRT thread of the L2-simulator and from the MUCE, a random access control channel (RACH) request and the RA-RNTI; pushing, by the at least one NRT thread to the first RT thread, a first RACH event based on the RA-RNTI; creating, by the first RT thread, a first UE-context associated with the UE and a first mapping of the first UE-context and the RA-RNTI; storing, by the first RT thread, the first UE-context and the first mapping in a repository; and pushing, by the first RT thread to the job pool, the first RACH event.

Further, the L2-simulator may be configured to distribute the UE context to the second RT thread by: executing, by the first RT thread, the first RACH event to send the RACH request and the RA-RNTI to the L1-forwarder of the DU; receiving, by the first RT thread and from the L1-forwarder of the DU, a random access response (RAR) that comprises the RA-RNTI and the C-RNTI; sending, by the first RT thread and to the second RT thread based on the C-RNTI, the first UE-context; creating, by the second RT thread, a second UE-context associated with the UE and a second mapping of the second UE-context and the C-RNTI; storing, by the second RT thread, the second UE-context and the second mapping in the repository; and pushing, by the second RT thread to the job pool, a second RACH event. In this regard, the second RT thread may be configured to post the second RACH event to the NRT thread, the second RACH event may include sending a message 3 (Msg3) to the DU after a predetermined period of time, and the NRT thread may be configured to execute the second RACH event after the predetermined period of time and instruct the MUCE to create the Msg3 and send the Msg3 to the DU thereafter.

### Example Network Architecture

As described above, a RAN may be disaggregated into various components like DU, CU, and RU. According to example embodiments, the RAN may be disaggregated based on Open RAN (O-RAN) technology. Thus, one or more components (and the operations associated therewith) describe hereinabove may be implemented in a telecommunications network based on an O-RAN architecture.

FIG. 8 illustrates a block diagram of an O-RAN architecture 800, according to one or more example embodiments. RAN functions in the O-RAN architecture may be controlled and optimized by a RAN Intelligent Controller (RIC). The RIC may be a software-defined component that implements modular applications to facilitate the multivendor operability required in the O-RAN system, as well as to automate and optimize RAN operations. As shown in FIG. 8, the RIC may be divided into two types: a non-real-time RIC (Non-RT RIC) 820 and a near-real-time RIC (Near-RT RIC) 830.

The Non-RT RIC 820 may be the control point of a non-real-time control loop and may operate on a timescale greater than 1 second within a Service Management and Orchestration (SMO) framework 810. Its functionalities may be implemented through modular applications called rApps, and may include: providing policy-based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which may be the interface that connects the SMO to RAN managed elements (e.g., Near-RT RIC 830, O-RAN Centralized Unit (O-CU) 840, O-RAN Distributed Unit (O-DU) 850, etc.).

The Near-RT RIC 830 may operate on a timescale between 10 milliseconds and 1 second and may be coupled with the O-DU 850, the O-CU 840 (which may disaggregated into the O-CU control plane (O-CU-CP) 840-1 and the O-CU user plane (O-CU-UP) 840-2), and an open evolved NodeB (O-eNB) 870 via the E2 interface. The Near-RT RIC 830 may use the E2 interface to control the underlying RAN elements (E2 nodes/network functions (NFs)) over a near-real-time control loop. The Near-RT RIC 830 may monitor, suspend/stop, override, and control the E2 nodes (O-CU 840, O-DU 850, and O-eNB 870) via policies. For example, the Near-RT RIC 830 may set policy parameters on activated functions of the E2 nodes. Further, the Near-RT RIC 830 may host xApps to implement functions such as quality of service (QoS) optimization, mobility optimization, slicing optimization, interference mitigation, load balancing, security, etc.

Here, the O-CU-CP 840-1 and the O-CU-UP 840-2 may be coupled to each other via the E1 interface, and may be coupled to the O-DU 850 via the F1-c interface and F1-u interface, respectively. Further, the O-RU 860 may be coupled to the O-DU 850 via the Open Fronthaul (OF) Control (C), User (U), Synchronization (S), and Management (M) Planes, and may be coupled to the SMO 810 via the OFM-Plane.

The two types of RICs work together to optimize the O-RAN. For example, the Non-RT RIC 820 may provide the policies, data, and AI/MLmodels enforced and used by the Near-RT RIC 830 for RAN optimization, and the Near-RT RIC 830 may return policy feedback (i.e., how the policy set by the Non-RT RIC 820 works).

As mentioned above, the Non-RT RIC 820 may be located within the SMO framework 810, which manages and orchestrates RAN elements. Specifically, the SMO810 may manage and orchestrate what is referred to as the O-RAN Cloud (O-Cloud) 880. The O-Cloud 880 may be a collection of physical RAN nodes that host the RICs, O-CUs, and O-DUs, the supporting software components (e.g., the operating systems and runtime environments), and the SMO 810 itself. In other words, the SMO 810 may manage the O-Cloud 880 from within. The O2 interface may be the interface between the SMO 810 and the O-Cloud 880 it resides in. Through the O2 interface, the SMO 810 may provide infrastructure management services (IMS) and deployment management services (DMS).

The O-CU 840, the O-DU 850, and the O-RU 860 may constitute a base station, such as a gNodeB (gNB) of 5G NR, a node in Next Generation Radio Access Network (NG-RAN), a base station of a 6G network, and the like. On the other hand, the O-eNB 870 may refer to a 4G LTE version of the O-RAN-compliant node (e.g., an eNB that adheres to the O-RAN architecture).

In some example implementations, the system may include a plurality of O-DUs 850, and the O-CU 840 may be communicatively coupled to the plurality of O-DUs. Similarly, the system may include a plurality of O-RUs 860, and the O-DU(s) 850 may be communicatively coupled to the plurality of O-RUs via one or more of the O-FH C/U/S/M plane interfaces.

According to example embodiments, the O-CU 840 and the O-DU 850 may be defined in software form and may be deployed in one or more network nodes. For instance, the O-CU 840 and the O-DU 850 may be deployed in one or more servers in the form of virtualized network function (VNF), containerized and/or cloud-native function (CNF), and the like. According to example embodiments, the O-CU 840 and the O-DU 850 may be deployed in the same network node (e.g., same server) and/or may be located at a similar geographical location (e.g., be deployed in different servers in the same data center). According to example embodiments, the O-CU 840 and the O-DU 850 may be deployed in different network nodes and/or may be located at different geographical locations. For instance, the O-CU 840 may be deployed in one or more central servers (i.e., servers in one or more central data centers), and the O-DU 850 may be deployed in one or more edge servers (i.e., servers in one or more edge data centers).

Further, a single O-DU 850 may host or serve multiple network cells formed by multiple O-RUs. According to example embodiments, the O-DU 850 may implement various radio technologies, such as massive multiple-input multiple-output (MIMO), beamforming, and the like, to optimize radio communication among the multiple cells and the O-CU 840. In some example implementations, the O-DU 850 may concurrently host or serve hundreds (e.g., 256, 512, etc.) of cells at a time.

The O-RU 860 may be a physical node that converts radio signals from antennas to digital signals that can be transmitted over the Front Haul to the O-DU 850. In this regard, a network cell described herein may correspond to one or more radio units responsible for providing wireless coverage and signal transmission within the network cell. The network cell may include a macro cell, a micro cell, a pico cell, a femto cell, and/or any other suitable type of network cell. Each of the cells may have an associated coverage area, in which at least one O-RU 860, at least one antenna system, and any other suitable type of transport network element (TNE), may be deployed therein.

In some example implementations, the example embodiments of the present disclosure may be implemented in an O-RAN-based telecommunication network. For instance, the UE simulator of example embodiments may be implemented to evaluate the O-DU 850, the UE simulator of example embodiments may be implemented in the O-Cloud 880, the UE simulator of example embodiments may communicate with the O-DU 850 (via an L1-forwarder implemented in the O-DU 850 and/or via the L1-layer of the O-DU 850) to thereby bypass the O-RU 860 during the simulation, and the like.

### Examples of Device

One or more components of the system of the example embodiments (e.g., UE-simulator, DU, etc.), as well as the operations associated therewith, may be implemented in one or more devices or hardware components. For instance, one or more components/operations of the system manager may be implemented in one or more devices like a server(s), and the like.

In the following, descriptions of a device in which the example embodiments may be implemented are provided. It is contemplated that one or more features, operations, and methods described above may be performed by the device. For instance, the one or more operations or methods may be performed by at least one processor of the device upon executing machine-readable instructions or computer-readable instructions stored in a memory or a storage component of the device.

FIG. 9 illustrates an embodiment of a device 900. As shown in FIG. 9, the device 900 may include a processor 910, a memory 920, a storage component 930, an input component 940, an output component 950, a communication interface 960, and a bus 970.

The processor 910, as used herein, means any type of computational circuit that may comprise hardware elements and software elements. The processor 910 may be embodied as a multi-core processor, a single core processor, or a combination of one or more multi-core processors and/or one or more single core processors, a distributed processing system, or the like. The processor 910 may be a Central Processing Unit (CPU), a graphics processing unit (GPU), an accelerated processing unit (APU), an application-specific integrated circuit (ASIC), or another type of processing component.

Memory 920 includes a non-transitory computer readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions when executed by the processor 910 cause the processor 910 to perform one or more method steps of an embodiment described above.

Storage component 930 stores information and/or software related to the operation and use of the device 900. For example, storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 940 is configured to receive information, such as user input. For example, the input component 940 may include, but not be limited to, a touch screen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

Output component 950 is configured to provide output information from the device 900. For example, the output component 950 may be, but not limited to, a display, a speaker, instructions to an external device, and/or one or more light-emitting diodes (LEDs).

Communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the device 900 and other devices. In other words, the standard of the communication interface 960 is not limited.

The bus 970 acts as an interconnect between the processor 910, the memory 920, the storage component 930, the input component 940, the output component 950, and the communication interface 960 of the device 900. The bus 970 may include a wired interconnection or a wireless interconnection.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900. Further, one or more method steps described in any of the embodiments may be performed utilizing a plurality of devices 900 in communication with one another.

### Various Aspects of Embodiments

Example embodiments of the present disclosure provide a device, system, method, and the like, that efficiently and effectively manage a simulated UE for evaluating the DU capacity. Specifically, example embodiments implement a UE simulator in which the functionalities or protocol stacks of a UE may be disaggregated into multiple components such that the hardware resources may be allocated to the specific components according to the requirements (e.g., a UE simulator for mainly evaluating the L2 capacity of the DU may have an L2-simulator that simulates main L2 functionalities and a MUCE that simulates common functionalities, a UE simulator for mainly evaluating the L3 capacity of the DU may have an L3-simulator that simulates main L3 functionalities and a MUCE that simulates common functionalities, etc.). The disaggregated components of the UE simulator may be configured to perform dedicated operations (e.g., the L2-simulator may perform operations to simulate specific L2 functionalities, the MUCE may perform operations to simulate L3 functionalities, etc.). In addition, the simulated UE or the UE-context associated therewith may be distributed among the components of the UE simulator (e.g., among different threads in the L2-simulator, etc.) according to the requirements of the simulation to balance the load of the UE simulator. As a result, the efficiency and effectiveness in simulating the UE and managing the simulated UE may be improved.

In addition, example embodiments of the present disclosure may also implement a virtual L1-forwarder in the DU such that the DU may directly communicate with the UE simulator via the L1-forwarder, without requiring an RU. Accordingly, the number of simulated UEs supported by the UE simulator may not be restricted due to the limitations of the RU.

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

In view of the above, various further respective aspects and features of embodiments of the present disclosure may be defined by the following items:
Item [1]: A user equipment (UE) simulator including: a Layer 2 (L2)-simulator and a Multi-UE Cell Emulator (MUCE). The L2-simulator may be communicatively coupled to the MUCE and a Layer 1 (L1)-forwarder of a distributed unit (DU) of a telecommunication network. The MUCE may be communicatively coupled to the L2-simulator and a test automation controller (TAC) configured to receive a simulation requirement from a user. The L2-simulator may be configured to receive a first data from the L1-forwarder of the DU and receive a second data from the MUCE. Further, the L2-simulator may be configured to forward the first data to the MUCE and forward the second data to the L1-forwarder of the DU. Furthermore, the L2-simulator may be configured to simulate, based on at least one of the first data and the second data, L2 functionalities of a UE. The MUCE may be configured to simulate, based on at least one of the first data and the simulation requirement, Layer 3 (L3) functionalities of the UE.
Item [2]: The UE simulator according to item [1], further including: a simulator forwarder communicatively coupled to the L2-simulator and the L1-forwarder of the DU. The simulator forwarder may be configured to receive the first data from the L1-forwarder of the DU and receive the second data from the L2-simulator. Further, the simulator forwarder may be configured to forward the first data to the L2-simulator and forward the second data to the L1-forwarder of the DU.
Item [3]: The UE simulator according to any of the items [1]-[2], wherein the L2-simulator may be configured to simulate a portion of packet data convergence protocol (PDCP) functionalities and the MUCE may be configured to simulate another portion of the PDCP functionalities.
Item [4]: The UE simulator according to any of the items [1]-[3], wherein the L2-simulator may be configured to simulate the L2 functionalities of the UE by: creating, based on at least one of the first data and the second data, UE-context associated with the UE; and simulating, based on the UE-context and at least one L2 protocol, data transmission to and data reception from the L1-forwarder of the DU.
Item [5]: The UE simulator according to item [4], wherein the L2-simulator may include multiple real-time (RT) threads. The L2-simulator may be configured to distribute the UE-context to a first RT thread based on a random access radio network temporary identifier (RA-RNTI) and distribute the UE-context to a second RT thread based on a cell RNTI (C-RNTI).
Item [6]: The UE simulator according to item [5], wherein the L2-simulator may be configured to receive the RA-RNTI from the MUCE and receive the C-RNTI from the DU.
Item [7]: The UE simulator according to any of items [5]-[6], wherein the L2-simulator may further include a plurality of non-real-time (NRT) threads and a job pool. The L2-simulator may be configured to distribute the UE-context to the first RT thread by: receiving, by at least one NRT thread of the L2-simulator and from the MUCE, a random access control channel (RACH) request and the RA-RNTI; pushing, by the at least one NRT thread to the first RT thread, a first RACH event based on the RA-RNTI; creating, by the first RT thread, a first UE-context associated with the UE and a first mapping of the first UE-context and the RA-RNTI; storing, by the first RT thread, the first UE-context and the first mapping in a repository; and pushing, by the first RT thread to the job pool, the first RACH event.
Item [8]: The UE simulator according to item [7], wherein the L2-simulator may be configured to distribute the UE-context to the second RT thread by: executing, by the first RT thread, the first RACH event to send the RACH request and the RA-RNTI to the L1-forwarder of the DU; receiving, by the first RT thread and from the L1-forwarder of the DU, a random access response (RAR) that comprises the RA-RNTI and the C-RNTI; sending, by the first RT thread and to the second RT thread based on the C-RNTI, the first UE-context; creating, by the second RT thread, a second UE-context associated with the UE and a second mapping of the second UE-context and the C-RNTI; storing, by the second RT thread, the second UE-context and the second mapping in the repository; and pushing, by the second RT thread to the job pool, a second RACH event.
Item [9]: The UE simulator according to item [8], wherein the second RT thread may be configured to post the second RACH event to the NRT thread. The second RACH event may include sending a message 3 (Msg3) to the DU after a predetermined period of time. The NRT thread may be configured to execute the second RACH event after the predetermined period of time and instruct the MUCE to create the Msg3 and send the Msg3 to the DU thereafter.
Item [10]: A method including: receiving, by a Layer 2 (L2)-simulator of a user equipment (UE) simulator, a first data from a Layer 1 (L1)-forwarder a distributed unit (DU) of a telecommunication network; forwarding, by the L2-simulator, the first data to a Multi-UE Cell Emulator (MUCE) of the UE simulator; receiving, by the L2-simulator, a second data from the MUCE; forwarding, by the L2-simulator, the second data to the L1-forwarder of the DU; simulating, by the L2-simulator and based on at least one of the first data and the second data, L2 functionalities of a UE; and simulating, by the MUCE and based on at least one of the first data and a simulation requirement received by the MUCE from a transaction controller (TAC), Layer 3 (L3) functionalities of the UE.
Item [11]: The method according to item [10], further including: receiving, by a simulator forwarder communicatively coupled to the L2-simulator and the L1-forwarder of the DU, the first data from the L1-forwarder; forwarding, by the simulator forwarder, the first data to the L2-simulator; receiving, by the simulator forwarder, the second data from the L2-simulator; and forwarding, by the simulator forwarder, the second data to the L1-forwarder.
Item [12]: The method according to any of items [10]-[11], further including: simulating, by the L2-simulator, a portion of packet data convergence protocol (PDCP) functionalities; and simulating, by the MUCE, another portion of the PDCP functionalities.
Item [13]: The method according to any of items [10]-[12], wherein the simulating the L2 functionalities of the UE may include: creating, by the L2-simulator and based on at least one of the first data and the second data, UE-context of the UE; and simulating, by the L2-simulator and based on the UE-context and at least one L2 protocol, data transmission to and data reception from the DU.
Item [14]: The method according to item [13], wherein the L2-simulator may include multiple real-time (RT) threads, and wherein the method may further include: distributing, by the L2-simulator and based on a random access radio network temporary identifier (RA-RNTI), the UE-context to a first RT thread; and distributing, by the L2-simulator and based on a cell RNTI (C-RNTI), the UE-context to a second RT thread.
Item [15]: The method according to item [14], further including: receiving, by the L2-simulator and from the MUCE, the RA-RNTI; and receiving, by the L2-simulator and

### From the Du, the C-rnti.

Item [16]: The method according to any of items [14]-[15], wherein the L2-simulator may further include a plurality of non-real-time (NRT) threads and a job pool, and wherein the distributing the UE-context to the first RT thread may include: receiving, by at least one NRT thread of the L2-simulator and from the MUCE, a random access control channel (RACH) request and the RA-RNTI; pushing, by the at least one NRT thread to the first RT thread, a first RACH event based on the RA-RNTI; creating, by the first RT thread, a first UE-context associated with the UE and a first mapping of the first UE-context and the RA-RNTI; storing, by the first RT thread, the first UE-context and the first mapping in a repository; and pushing, by the first RT thread to the job pool, the first RACH event.
Item [17]: The method according to item [16], wherein the distributing the UE-context to the second RT thread may include: executing, by the first RT thread, the first RACH event to send the RACH request and the RA-RNTI to the L1-forwarder of the DU; receiving, by the first RT thread from the L1-forwarder of the DU, a random access response (RAR) that comprises the RA-RNTI and the C-RNTI; sending, by the first RT thread to the second RT thread based on the C-RNTI, the first UE-context; creating, by the second RT thread, a second UE-context associated with the UE and a second mapping of the second UE-context and the C-RNTI; storing, by the second RT thread, the second UE-context and the second mapping in the repository; and pushing, by the second RT thread to the job pool, a second RACH event.
Item [18]: The method according to item [17], further including: posting, by the second RT thread, the second RACH event to the at least one NRT thread, wherein the second RACH event may include sending a message 3 (Msg3) to the DU after a predetermined period of time; and executing, by the at least one NRT thread, the second RACH event after the predetermined period of time to thereby instruct the MUCE to create the Msg3 and send the Msg3 to the DU thereafter.
Item [19]: A non-transitory computer-readable recording medium having recorded thereon instructions executable by a user equipment (UE) simulator to cause the UE simulator to perform a method. The method may include: receiving, by a Layer 2 (L2)-simulator of the UE simulator, a first data from a Layer 1 (L1)-forwarder a distributed unit (DU) of a telecommunication network; forwarding, by the L2-simulator, the first data to a Multi-UE Cell Emulator (MUCE) of the UE simulator; receiving, by the L2-simulator, a second data from the MUCE; forwarding, by the L2-simulator, the second data to the L1-forwarder of the DU; simulating, by the L2-simulator and based on at least one of the first data and the second data, L2 functionalities of a UE; and simulating, by the MUCE and based on at least one of the first data and a simulation requirement received by the MUCE from a transaction controller (TAC), Layer 3 (L3) functionalities of the UE.
Item [20]: The non-transitory computer-readable recording medium according to item [19], wherein the method may further include: receiving, by a simulator forwarder communicatively coupled to the L2-simulator and the L1-forwarder of the DU, the first data from the L1-forwarder; forwarding, by the simulator forwarder, the first data to the L2-simulator; receiving, by the simulator forwarder, the second data from the L2-simulator; and forwarding, by the simulator forwarder, the second data to the L1-forwarder.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A user equipment (UE) simulator comprising:
a Layer 2 (L2)-simulator communicatively coupled to a Multi-UE Cell Emulator (MUCE) and a Layer 1 (L1)-forwarder of a distributed unit (DU) of a telecommunication network; and
the MUCE, wherein the MUCE is communicatively coupled to the L2-simulator and a test automation controller (TAC) configured to receive a simulation requirement from a user;
wherein the L2-simulator is configured to:
receive a first data from the L1-forwarder of the DU and receive a second data from the MUCE;
forward the first data to the MUCE and forward the second data to the L1-forwarder of the DU; and
simulate, based on at least one of the first data and the second data, L2 functionalities of a UE; and
wherein the MUCE is configured to simulate, based on at least one of the first data and the simulation requirement, Layer 3 (L3) functionalities of the UE.

2. The UE simulator according to claim 1, further comprising:
a simulator forwarder communicatively coupled to the L2-simulator and the L1-forwarder of the DU;
wherein the simulator forwarder is configured to receive the first data from the L1-forwarder of the DU and receive the second data from the L2-simulator; and
wherein the simulator forwarder is configured to forward the first data to the L2-simulator and forward the second data to the L1-forwarder of the DU.

3. The UE simulator according to claim 1, wherein the L2-simulator is configured to simulate a portion of packet data convergence protocol (PDCP) functionalities and the MUCE is configured to simulate another portion of the PDCP functionalities.

4. The UE simulator according to claim 1, wherein the L2-simulator is configured to simulate the L2 functionalities of the UE by:
creating, based on at least one of the first data and the second data, UE-context associated with the UE; and
simulating, based on the UE-context and at least one L2 protocol, data transmission to and data reception from the L1-forwarder of the DU.

5. The UE simulator according to claim 4, wherein the L2-simulator comprises multiple real-time (RT) threads, wherein the L2-simulator is configured to distribute the UE-context to a first RT thread based on a random access radio network temporary identifier (RA-RNTI), and wherein the L2-simulator is configured to distribute the UE-context to a second RT thread based on a cell RNTI (C-RNTI).

6. The UE simulator according to claim 5, wherein the L2-simulator is configured to receive the RA-RNTI from the MUCE and receive the C-RNTI from the DU.

7. The UE simulator according to claim 5, wherein the L2-simulator further comprises a plurality of non-real-time (NRT) threads and a job pool, and wherein the L2-simulator is configured to distribute the UE-context to the first RT thread by:
receiving, by at least one NRT thread of the L2-simulator and from the MUCE, a random access control channel (RACH) request and the RA-RNTI;
pushing, by the at least one NRT thread to the first RT thread, a first RACH event based on the RA-RNTI;
creating, by the first RT thread, a first UE-context associated with the UE and a first mapping of the first UE-context and the RA-RNTI;
storing, by the first RT thread, the first UE-context and the first mapping in a repository; and
pushing, by the first RT thread to the job pool, the first RACH event.

8. The UE simulator according to claim 7, wherein the L2-simulator is configured to distribute the UE-context to the second RT thread by:
executing, by the first RT thread, the first RACH event to send the RACH request and the RA-RNTI to the L1-forwarder of the DU;
receiving, by the first RT thread and from the L1-forwarder of the DU, a random access response (RAR) that comprises the RA-RNTI and the C-RNTI;
sending, by the first RT thread and to the second RT thread based on the C-RNTI, the first UE-context;
creating, by the second RT thread, a second UE-context associated with the UE and a second mapping of the second UE-context and the C-RNTI;
storing, by the second RT thread, the second UE-context and the second mapping in the repository; and
pushing, by the second RT thread to the job pool, a second RACH event.

9. The UE simulator according to claim 8, wherein the second RT thread is configured to post the second RACH event to the NRT thread, wherein the second RACH event comprises sending a message 3 (Msg3) to the DU after a predetermined period of time, and wherein the NRT thread is configured to execute the second RACH event after the predetermined period of time and instruct the MUCE to create the Msg3 and send the Msg3 to the DU thereafter.

10. A method comprising:
receiving, by a Layer 2 (L2)-simulator of a user equipment (UE) simulator, a first data from a Layer 1 (L1)-forwarder a distributed unit (DU) of a telecommunication network;
forwarding, by the L2-simulator, the first data to a Multi-UE Cell Emulator (MUCE) of the UE simulator;
receiving, by the L2-simulator, a second data from the MUCE;
forwarding, by the L2-simulator, the second data to the L1-forwarder of the DU;
simulating, by the L2-simulator and based on at least one of the first data and the second data, L2 functionalities of a UE; and
simulating, by the MUCE and based on at least one of the first data and a simulation requirement received by the MUCE from a transaction controller (TAC), Layer 3 (L3) functionalities of the UE.

11. The method according to claim 10, further comprising:
receiving, by a simulator forwarder communicatively coupled to the L2-simulator and the L1-forwarder of the DU, the first data from the L1-forwarder;
forwarding, by the simulator forwarder, the first data to the L2-simulator;
receiving, by the simulator forwarder, the second data from the L2-simulator; and
forwarding, by the simulator forwarder, the second data to the L1-forwarder.

12. The method according to claim 10, further comprising:
simulating, by the L2-simulator, a portion of packet data convergence protocol (PDCP) functionalities; and
simulating, by the MUCE, another portion of the PDCP functionalities.

13. The method according to claim 10, wherein the simulating the L2 functionalities of the UE comprises:
creating, by the L2-simulator and based on at least one of the first data and the second data, UE-context of the UE; and
simulating, by the L2-simulator and based on the UE-context and at least one L2 protocol, data transmission to and data reception from the DU.

14. The method according to claim 13, wherein the L2-simulator comprises multiple real-time (RT) threads, and wherein the method further comprises:
distributing, by the L2-simulator and based on a random access radio network temporary identifier (RA-RNTI), the UE-context to a first RT thread; and
distributing, by the L2-simulator and based on a cell RNTI (C-RNTI), the UE-context to a second RT thread.

15. The method according to claim 14, further comprising:
receiving, by the L2-simulator and from the MUCE, the RA-RNTI; and
receiving, by the L2-simulator and from the DU, the C-RNTI.

16. The method according to claim 14, wherein the L2-simulator further comprises a plurality of non-real-time (NRT) threads and a job pool, and wherein the distributing the UE-context to the first RT thread comprises:
receiving, by at least one NRT thread of the L2-simulator and from the MUCE, a random access control channel (RACH) request and the RA-RNTI;
pushing, by the at least one NRT thread to the first RT thread, a first RACH event based on the RA-RNTI;
creating, by the first RT thread, a first UE-context associated with the UE and a first mapping of the first UE-context and the RA-RNTI;
storing, by the first RT thread, the first UE-context and the first mapping in a repository; and
pushing, by the first RT thread to the job pool, the first RACH event.

17. The method according to claim 16, wherein the distributing the UE-context to the second RT thread comprises:
executing, by the first RT thread, the first RACH event to send the RACH request and the RA-RNTI to the L1-forwarder of the DU;
receiving, by the first RT thread from the L1-forwarder of the DU, a random access response (RAR) that comprises the RA-RNTI and the C-RNTI;
sending, by the first RT thread to the second RT thread based on the C-RNTI, the first UE-context;
creating, by the second RT thread, a second UE-context associated with the UE and a second mapping of the second UE-context and the C-RNTI;
storing, by the second RT thread, the second UE-context and the second mapping in the repository; and
pushing, by the second RT thread to the job pool, a second RACH event.

18. The method according to claim 17, further comprising:
posting, by the second RT thread, the second RACH event to the at least one NRT thread, wherein the second RACH event comprises sending a message 3 (Msg3) to the DU after a predetermined period of time; and
executing, by the at least one NRT thread, the second RACH event after the predetermined period of time to thereby instruct the MUCE to create the Msg3 and send the Msg3 to the DU thereafter.

19. A non-transitory computer-readable recording medium having recorded thereon instructions executable by a user equipment (UE) simulator to cause the UE simulator to perform a method comprising:
receiving, by a Layer 2 (L2)-simulator of the UE simulator, a first data from a Layer (L1)-forwarder a distributed unit (DU) of a telecommunication network;
forwarding, by the L2-simulator, the first data to a Multi-UE Cell Emulator (MUCE) of the UE simulator;
receiving, by the L2-simulator, a second data from the MUCE;
forwarding, by the L2-simulator, the second data to the L1-forwarder of the DU;
simulating, by the L2-simulator and based on at least one of the first data and the second data, L2 functionalities of a UE; and
simulating, by the MUCE and based on at least one of the first data and a simulation requirement received by the MUCE from a transaction controller (TAC), Layer 3 (L3) functionalities of the UE.

20. The non-transitory computer-readable recording medium according to claim 19, wherein
the method further comprises:
receiving, by a simulator forwarder communicatively coupled to the L2-simulator and the L1-forwarder of the DU, the first data from the L1-forwarder;
forwarding, by the simulator forwarder, the first data to the L2-simulator;
receiving, by the simulator forwarder, the second data from the L2-simulator; and
forwarding, by the simulator forwarder, the second data to the L1-forwarder.
